(19) United States
(12) Patent Application Publication
(10) Pub. No.: US 2020/0146297 A1
(43) Pub. Date: May 14, 2020

(54) FAST SYMPTOM HERBICIDAL COMPOSITIONS CONTAINING AN ORGANOPHOSPHORUS HERBICIDE, BIPYRIDILIUM AND ALKOXYLATED ALCOHOL SURFACTANT

(71) Applicant: Monsanto Technology LLC, St. Louis, MO (US)

(72) Inventors: Paul G. Ratliff, Olivette, MO (US); Daniel R. Wright, St. Louis, MO (US)

(73) Assignee: Monsanto Technology LLC, St. Louis, MO (US)

(21) Appl. No.: 16/336,540

(22) PCT Filed: Sep. 21, 2017
(86) PCT No.: PCT/US2017/052623

§ 371 Date: Mar. 26, 2019

Related U.S. Application Data
(60) Provisional application No. 62/399,641, filed on Sep. 26, 2016.

(51) Int. Cl. A01N 57/20; A01N 43/90; A01N 25/30

(52) U.S. Cl. CPC A01N 57/20; A01N 25/30; A01N 43/90

(57) ABSTRACT

The present invention relates to herbicidal compositions and methods for killing or controlling the growth and proliferation of unwanted plants. The herbicidal compositions of the present invention cause earlier visual symptoms of treatment (e.g., phytotoxic effects) and/or enhanced effectiveness when applied to foliage of plants. The herbicidal compositions of the present invention include an organophosphorus herbicide or a herbicidal derivative thereof (e.g., glyphosate), a bipyridilium or a herbicidal derivative thereof and an alkoxylated alcohol surfactant. The compositions of the present invention are formulated as ready-to-use (RTU) formulations.

### FIELD OF THE INVENTION

The present invention relates to herbicidal compositions and methods for killing or controlling the growth and proliferation of unwanted plants. The herbicidal compositions of the present invention cause earlier visual symptoms of treatment (e.g., phytotoxic effects) and/or enhanced effectiveness when applied to foliage of plants. The herbicidal compositions of the present invention include an organophosphorus herbicide or a herbicidal derivative thereof (e.g., glyphosate), a bipyridilium or a herbicidal derivative thereof, and an alkoxylated alcohol surfactant. The compositions of the present invention are formulated as ready-to-use (RTU) formulations.

### BACKGROUND OF THE INVENTION

Herbicidal compositions comprising organophosphorus herbicides including the herbicide N-phosphonomethylglycine or derivatives thereof (“glyphosate”) and the herbicide phosphinothricin or derivatives thereof (“glufosinate”) are useful for suppressing the growth of or killing unwanted plants such as grasses, weeds, and the like. Glyphosate typically is applied to the foliage of the target plant. After application the glyphosate is absorbed by the foliar tissue of the plant and translocated throughout the plant. Glyphosate blocks an important biochemical pathway which is common to virtually all plants, but which is absent in animals. Although glyphosate is very effective in killing or controlling the growth of unwanted plants, the uptake (i.e., absorption) of glyphosate by the plant foliar tissue and translocation of glyphosate throughout the plant is relatively slow. Visual symptoms that a plant has been treated with glyphosate may not appear until one week or more after treatment.

Early visual symptoms of plant treatment can be achieved by using compositions comprising glyphosate and the contact herbicide pelargonic acid. However, such compositions may have one or more drawbacks. First, they require high application rates of the pelargonic acid. Second, pelargonic acid alone often does not permanently kill plants, but attacks the plant very rapidly so that the glyphosate may have insufficient time to translocate into the plant to completely and permanently kill the plant. This drawback is particularly evident when the compositions are used to treat perennial plants such as, but not limited to, Johnsongrass. Third, glyphosate+pelargonic acid compositions are difficult to prepare in a stable formulation; the formulations frequently separate. Even a tank mix requires essentially constant agitation to prevent the pelargonic acid from separating out. Since pelargonic acid is difficult to formulate in a concentrate, compositions of glyphosate and pelargonic acid are typically sold in dilute “ready-to-use” formulations.

Often, in ready-to-use formulations, pelargonic acid is used along with glyphosate and particular additives and surfactants (e.g., ammonium sulfate and other nonionic surfactants such as alkylethoxylate surfactants). Such formulations have proven effective in providing early and rapid phytotoxicity. However, such formulations have been found to suffer a drawback of leaving a residue on pavement and concrete surfaces. Such residue is often undesirable to consumers.

Therefore, a need exists for a ready-to-use formulation that provides rapid phytotoxicity, but avoids the above-noted problems associated with ready-to-use pelargonic acid-containing formulations (e.g., leaving a residue on certain surfaces). A further need exits for a ready-to-use formulation that provides a composition resulting in rapid phytotoxicity, but also provides permanent kill by allowing sufficient time for glyphosate to translocate into the plant and completely kill the plant.

Herbicidal compositions comprising the herbicide dihydrodipyrido(1,2-a:2′,1′-c)pyrazinediium or derivatives thereof (“diquat”) or another bipyridilium, paraquat, also are useful for suppressing the growth of or killing unwanted grasses, weeds, and the like. This contact herbicide typically is applied to the foliage of the target plant and causes rapid disruption of plant cell membranes. It primarily is used as a herbicide to control weeds in noncrop and aquatic areas. Visual symptoms that a plant has been treated with diquat typically appear within 1 to 3 days of application, depending on environmental conditions.

Compositions containing glyphosate along with a bipyridilium (such as diquat or paraquat) are known. Such compositions are known that allow the plant to uptake a herbicidally effective amount of the glyphosate prior to the substantial onset of bipyridilium induced leaf damage that would prevent or severely reduce further uptake of glyphosate by the plant. Use of such novel compositions for the control of unwanted plants provides rapid bipyridilium symptomology (e.g., rapid burndown) yet with the long term control expected of glyphosate-based herbicides. However, there exists a need for glyphosate+bipyridilium formulations (e.g., ready-to-use formulations) that provide even more rapid symptoms of phytotoxicity. Providing more rapid phytotoxicity makes the formulations of the present invention particularly suitable for RTU formulations. Rapid phytotoxicity is particularly advantageous for formulations sold to home-owners and other non-professionals in the agricultural field as a lack of rapid phytotoxicity could lead them to needlessly re-apply or over-apply the formulation.

### SUMMARY OF THE INVENTION

In accordance with the present invention it has been discovered that incorporating an alcohol alkoxylate surfactant into organophosphorus herbicide (e.g., glyphosate)+bipyrilidium compositions provides improved effectiveness under various conditions and at different stages, including improvements in regard to rapid evidence of phytotoxic effects and also improvements in connection with extended control. It has further been discovered in accordance with the present invention that the inventive formulations provide rapid phytotoxic effects similar to glyphosate+pelargonic acid-containing formulations, but without the undesirable residue on various surfaces, including pavement surfaces and concrete surfaces.

Typically, the compositions of the present invention are provided to the end-user already formulated at the desired dilution for application (i.e., as a “ready to use” composition). The herbicidal compositions of the invention can also be prepared on site by the end-user shortly before application to the foliage of the vegetation to be killed or controlled by mixing in aqueous solution a glyphosate containing composition; a bipyridilium containing composition; and the alkoxylated alcohol surfactant. Such compositions are typically referred to as “tank-mix” compositions.

Briefly, therefore, the present invention is directed to herbicidal compositions useful for killing or controlling the growth of unwanted plants, the compositions comprising: (a) an organophosphorus herbicide or a herbicidal derivative thereof (e.g., glyphosate or a herbicidal derivative thereof); (b) bipyridilium or a herbicidal derivative thereof; and (c) an alkoxylated alcohol surfactant.

In certain such embodiments, the bipyridilium (ce) is present at a weight ratio to the alkoxylated alcohol surfactant to bipyridilium (ce) of less than about 0.1:1.

In other such embodiments, the weight ratio of alkoxylated alcohol surfactant to glyphosate (ae) is greater than about 0.75:1.

In further such embodiments, glyphosate (ae) is present at a concentration of from about 0.25 wt % to about 2 wt %; bipyridilium (ce) is present at a concentration of from about 0.01 wt % to about 1 wt %; and the alkoxylated alcohol surfactant is present at a concentration of from about 0.25 wt % to about 2 wt %.

In still further such embodiments, the composition does not comprise an inorganic ammonium salt selected from the group consisting of ammonium sulfate, ammonium nitrate, ammonium thiocyanate, ammonium phosphate, ammonium chloride and mixtures thereof.

In additional such embodiments, the composition further comprises an active selected from the group consisting of 2,4-D, 2,4-DB, MCPA, dicamba, glufosinate, glyphosate, imazapic, imazapyr, imazethapyr, triclopyr, and combinations thereof.

The present invention is further directed to methods of killing or controlling weeds or unwanted vegetation, the method comprising applying a herbicidally effective amount of a composition of the present invention to the foliage of the weeds or unwanted vegetation, wherein greater visual symptoms of herbicidal treatment are provided within 1 hour after treatment, 3 hours after treatment, 1 day after treatment (1 DAT), 3 DAT, 14 DAT, and/or 21 DAT as compared to a reference application mixture that did not contain the alkoxylated alcohol surfactant.

Other objects and features will be in part apparent and in part pointed out hereinafter.

### DETAILED DESCRIPTION OF THE PREFERRED EMBODIMENTS

In accordance with the present invention it has been discovered that combining an organophosphorus herbicide (e.g., glyphosate) with diquat dibromide and an alcohol ethoxylate surfactant provides formulations, in particular RTU formulations that provide multiple advantages over various conventional formulations. Glyphosate plus pelargonic acid-containing formulations are known to provide rapid phytotoxic effects, but often leave an undesirable residue on certain surfaces (e.g., pavement and concrete). The formulations of the present invention that do not include pelargonic acid overcome this residue issue. However, the present invention does not simply involve removing pelargonic acid to avoid leaving a residue on certain surfaces.

Diquat dibromide and glyphosate formulations are known, typically in connection with overall and extended weed control. The present invention includes the discovery that diquat dibromide can be combined with glyphosate, and further along with the alcohol ethoxylate surfactant to provide these results along with rapid phytotoxicity.

Diquat dibromide and pelargonic acid are known to function in different manners. Therefore, it was surprisingly discovered that diquat dibromide could be formulated in a composition along with glyphosate to provide rapid phytotoxicity along with extended control as provided by glyphosate-pelargonic acid formulations. Advantageously, these compositions avoid the residue issue associated with pelargonic acid. Along with these surprising and advantageous effects, lower amounts of diquat dibromide than amounts of pelargonic acid typically used have been discovered to provide effective formulations. This allows for readily formulating ready-to-use (RTU) formulations that contain a low proportion of the diquat dibromide component as defined in terms of the proportion or concentration of diquat dibromide present and/or in terms of the relative proportion of the diquat dibromide component as compared to other components of the formulation.

The present invention also involves the surprising discovery that the glyphosate+diquat dibromide+alcohol ethoxylate combination provides more rapid phytotoxicity as compared to the combination of glyphosate and an alcohol ethoxylate (which was already known to provide phytotoxicity).

In accordance with the present invention, aqueous herbicidal glyphosate compositions are provided, in particular sprayable, RTU formulations that are capable of inducing early, visually apparent, phytotoxic effects while minimizing antagonism to the glyphosate component of the composition and also providing the desired attribute of prolonged control of the treated plants.

The herbicidal compositions of the present invention containing glyphosate, a bipyridilium and an alcohol ethoxylate surfactant provide rapid uptake by the target plant, early visual symptoms of plant treatment, and control of a broad spectrum of plant species. In certain other embodiments of the present invention, the composition comprises glufosinate and bipyridilium along with the alcohol ethoxylate surfactant. Glufosinate-containing formulations typically do not contain glyphosate.

The compositions of the present invention comprise at least two herbicides (i.e., glyphosate and a bipyridilium) and at least the alcohol ethoxylate surfactant. In various embodiments a first component of the compositions of the present invention is N-(phosphonomethyl)glycine (“glyphosate”), a salt, adduct or ester thereof, or a compound which is converted to glyphosate in plant tissues or which otherwise provides glyphosate ion. The term “glyphosate” when used herein is to be understood to encompass such derivatives unless the context requires otherwise.

The herbicidal compositions of the present invention are applied as aqueous solutions or dispersions. However, the term “aqueous,” as used herein, is not intended to exclude the presence of nonaqueous (i.e., organic) solvents, as long as water is present. Water is the predominant component of the aqueous RTU compositions disclosed herein.

Glyphosate Component

Suitable salts of N-(phosphonomethyl)glycine include mono-, di- or tribasic and include organic ammonium, alkali metal, alkaline earth metal, ammonium (e.g., mono-, di- or triammonium) and sulfonium (e.g., mono-, di- or trimethylsulfonium) salts of N-(phosphonomethyl)glycine. The organic ammonium salts can comprise aliphatic or aromatic ammonium salts and can include primary, secondary, tertiary or quaternary ammonium salts. Specific representative examples of such organic ammonium salts include isopropylammonium, n-propylammonium, ethylammonium, dimethylammonium, 2-hydroxyethylammonium (also referred to as monoethanolammonium), ethylenediamine and hexamethylenediamine salts of N-(phosphonomethyl)glycine. Specific representative examples of alkali metal salts include potassium and sodium salts of N-(phosphonomethyl)glycine.

In accordance with certain embodiments of the invention, the glyphosate component predominantly comprises a salt of N-(phosphonomethyl)glycine selected from the potassium, monoammonium, diammonium, sodium, monoethanolammonium, n-propylammonium, isopropylammonium, ethylammonium, dimethylammonium, ethylenediamine, hexamethylenediamine and trimethylsulfonium salts and combinations thereof.

In certain preferred embodiments, the isopropylammonium (IPA), ammonium and/or potassium salts and combinations thereof are utilized.

Generally, the concentration of the glyphosate component (ae) in aqueous RTU compositions of the present is from about 0.1 wt % to about 5 wt %, or from about 0.1 wt % to about 2 wt %.

Typically, glyphosate (ae) is present in RTU compositions of the present invention at a concentration of at least about 0.25 wt %, at least about 0.5 wt %, or at least about 0.75 wt %. In certain embodiments, glyphosate (ae) is present at a concentration of from about 0.25 wt % to about 2 wt %, from about 0.5 to about 1.5 wt %, or from about 0.5 to about 1 wt %.

Bipyridilium Component

A bipyridilium is the second component of the compositions of the present invention. Bipyridiliums are the general class of herbicides that include diquat and paraquat. Compounds in this class are characterized by very rapid symptomology. It is believed that the rapid symptomology of the bipyridiliums is a result of their ability to react with photosynthetic mechanisms in plants. The production of superoxides and hydrogen peroxides leads to massive disruption of cells and their physiological processes in any tissues that are contacted. The mode of action of diquat and other members of this class is described in the Herbicide Handbook of WSSA, 7^{th} Edition, 1994. Both diquat and paraquat are tightly bound to soil.

The preferred bipyridilium present in the herbicidal compositions of the present invention is Diquat [6,7-dihydrodipyrido (1,2-a:2′,1′-c)pyrazinediium], a salt or adduct thereof, or a compound which otherwise provides the diquat cation. The term “diquat” when used herein is to be understood to encompass such derivatives unless the context requires otherwise.

Salts of diquat are commercially significant in part because they are water soluble, which allows for ready incorporation into compositions of the present invention (e.g., RTU formulations containing all required components and tank mixtures where diquat is combined with the other components on site).

In lieu of diquat, a less preferred bipyridilium that may be used is 1,1′-Dimethyl-4,4′-bipyridinium dichloride (paraquat dichloride), a salt or adduct thereof, or a compound which otherwise provides the paraquat cation. The term “paraquat” when used herein is to be understood to encompass such derivatives unless the context requires otherwise.

As detailed, the diquat (i.e., bipyridilium) component of the compositions of the present invention is believed to be the component that generally provides the fast herbicidal activity and symptomology. Advantageously in accordance with the present invention, this component may be incorporated in a relatively low proportion, both in terms of its concentration in the composition and proportion relative to one or more other components of the composition.

Generally, bipyridilium (ce) is present in RTU compositions of the present invention at a concentration of less than about 1 wt %, less than about 0.5 wt %, less than about 0.25 wt %, or less than about 0.2 wt/o. Typically, bipyridilium (ce) is present at a concentration of less than about 0.15 wt %, less than about 0.1 wt %, or less than about 0.05 wt %.

Bipyridilium (ce) is typically present in RTU formulations of the present invention at a concentration of from about 0.01 to about 1 wt %, from about 0.01 to about 0.5 wt %, from about 0.01 to about 0.25 wt %, from about 0.01 to about 0.1 wt %, or from about 0.01 to about 0.05 wt %.

Generally, the weight ratio of organophosphorus herbicide (e.g., glyphosate) (ae) to bipyridilium (ce) is at least about 10:1, at least about 15:1, at least about 20:1, at least about 25:1, at least about 30:1, or at least about 35:1. In certain embodiments, the weight ratio of organophosphorus herbicide (e.g., glyphosate) (ae) to bipyridilium (ce) is from about 10:1 to about 50:1, from about 15:1 to about 45:1, from about 20:1 to about 40:1, from about 25:1 to about 40:1, from about 30:1 to about 40:1, or from about 35:1 to about 40:1.

Generally, bipyridilium (ce) is present at a weight ratio to the alkoxylated alcohol surfactant to bipyridilium (ce) of less than about 0.1:1, less than about 0.09:1, less than about 0.08:1, less than about 0.07:1, less than about 0.06:1, or less than about 0.05:1. Typically bipyridilium (ce) is present at a weight ratio to the alkoxylated alcohol surfactant to bipyridilium (ce) of less than about 0.04:1, less than about 0.03:1, or less than about 0.02:1.

Alkoxylated Alcohol Surfactant Component

Along with the organophosphorus herbicide and the bipyridilium component (i.e., diquat), the compositions of the present invention include an alcohol alkoxylate surfactant, typically an alcohol ethoxylate surfactant. It was surprising that combining this surfactant with an organophosphorus herbicide and the diquat herbicide—particularly at a low diquat concentration—provides a fast acting herbicide.

Generally, the alkoxylated alcohol surfactant is included in RTU formulations of the present invention at a concentration of at least about 10 g/L, at least about 12 g/L, at least about 15 g/L, or at least about 20 g/L. The alkoxylated alcohol surfactant may be present at a concentration of from about 0.25 wt % to about 2 wt %.

Overall, the weight ratio of alkoxylated alcohol surfactant to organophosphorus herbicide (e.g., glyphosate) (ae) is generally greater than about 0.75:1, greater than about 1:1, greater than about 1.25:1, greater than about 1.5:1, greater than about 2:1, or greater than about 2.5:1. In accordance with these and certain other embodiments, the weight ratio of alkoxylated alcohol surfactant to organophosphorus herbicide (e.g., glyphosate) (ae) is less than about 5:1 or less than about 4:1.

The alkoxylated alcohol surfactant utilized in accordance with the present invention is generally of the following formula:

R¹O—(R²O)ₓR³

wherein R¹ is nonaromatic, hydrocarbyl or substituted hydrocarbyl having from 8 to 20 carbon atoms, R² in each of the x (R²O) groups is independently C₂ to C₄ alkylene, R³ is hydrogen, or a linear or branched alkyl group having from 1 to about 4 carbon atoms, and the average degree of alkoxylation, x, is from about 2 to about 20. It has been observed that alkoxylated aromatic alcohols (e.g., alkoxylated nonylphenol) and highly branched, alkoxylated alcohols (e.g., alkoxylated isotridecyl alcohol) are not particularly useful in enhancing early visual phytotoxic effects in treated plants. Accordingly, in this context, it is preferred that the nonionic surfactant comprise an alkoxylated, primary or secondary, linear or minimally branched (i.e., acyclic) C₈ to C₂₀, preferably C₁₀ to C₁₄, alcohol such that the preferred R¹ hydrocarbyl groups are linear or minimally branched alkyl, alkenyl or alkynyl groups having from 8 to 20 carbon atoms, preferably from 10 to 14 carbon atoms, and no more than two methyl substituents. Preferably, R¹ is a linear or minimally branched alkyl or alkenyl group having from 8 to 20 carbon atoms, preferably from 10 to 14 carbon atoms, and no more than two methyl substituents, R² in each of the x (R²O) groups is independently ethylene or propylene, preferably ethylene, R³ is hydrogen, methyl or ethyl, and the average degree of alkoxylation (e.g., ethoxylation), x, is from about 3 to about 12, more preferably from about 5 to about 9. More preferably, R¹ is a linear or minimally branched alkyl group having from 8 to 20 carbon atoms, preferably from 10 to 14 carbon atoms, and no more than two methyl substituents, R² in each of the x (R²O) groups is ethylene, R³ is hydrogen or methyl, and the average degree of ethoxylation, x, is from about 3 to about 12, more preferably from about 5 to about 9.

Examples of suitable commercially available alkoxylated, linear alcohols for use in the nonionic surfactant component include alcohol ethoxylates sold under the name TOMADOL by Air Products and Chemicals, Inc. (Allentown, Pa.) and including TOMADOL 25-3, TOMADOL 25-7 and TOMADOL 25-9 (made from linear C₁₂ to C₁₅ alcohols with an average of 2.8 moles, 7 moles and 9 moles of ethoxylation, respectively) and TOMADOL 1-5 and TOMADOL 1-7 (having an average of 5 moles and 7 moles of ethoxylation, respectively). Other commercially available alkoxylated, linear alcohols that may be used in the nonionic surfactant component are those in the TERGITOL series from Dow and commercially available from Sigma-Aldrich Co. (Saint Louis, Mo.), including TERGITOL-15-S-9, TERGITOL-15-S-12 and TERGITOL-15-S-15 (made from secondary, linear C₁₁ to C₁₅ alcohols with an average of 9 moles, 12.3 moles and 15.5 moles of ethoxylation, respectively); and the SURFONIC LF-X series from Huntsman Chemical Co. (Salt Lake City, Utah), including L12-7 (made from linear C₁₀ to C₁₂ alcohols with an average of 7 moles of ethoxylation), L24-7, L24-9 and L24-12 (made from linear C₁₂ to C₁₄ alcohols with an average of 7 moles, 9 moles and 12 moles of ethoxylation, respectively), and L26-6.5 (made from linear C₁₂ to C₁₆ alcohols with an average of 6.5 moles of ethoxylation).

In certain embodiments, the alkoxylated alcohol surfactant has the formula:

R¹O—(R²O)ₓR³

wherein R¹ is nonaromatic, hydrocarbyl or substituted hydrocarbyl having from 8 to 20 carbon atoms; R² in each of the x (R²O) groups is independently C₂ to C₄ alkylene; R³ is hydrogen, or a linear or branched alkyl group having from 1 to 4 carbon atoms; and x is from about 2 to about 20. In certain embodiments, R¹ is a linear or minimally branched alkyl or alkenyl group having an average of from 8 to 20 carbon atoms, or from 10 to 14 carbon atoms, and no more than two methyl substituents. In certain embodiments, R¹ is a linear alkyl or alkenyl group having an average of from 8 to 20 carbon atoms, or from 10 to 14 carbon atoms, and no more than two methyl substituents. In certain embodiments, each R²O group is ethylene. Generally, the average value of x is from about 3 to about 12 or from about 5 to about 9.

Additional Surfactants

Various additional surfactants may be incorporated into compositions of the present invention including, for example, the following types of surfactants.

Aminated alkoxylated alcohols having the formula:

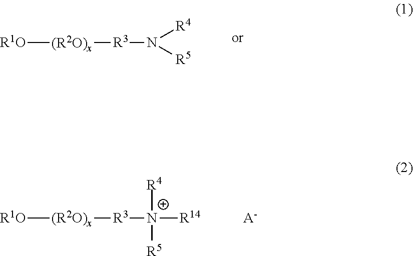

wherein R¹ is hydrogen or hydrocarbyl or substituted hydrocarbyl having from 1 to about 30 carbon atoms; R² in each of the x (R²O) and y (R²O) groups is independently C₂-C₄ alkylene; R³ and R⁶ are each independently hydrocarbylene or substituted hydrocarbylene having from 1 to about 6 carbon atoms; R⁴ is hydrogen, hydrocarbyl or substituted hydrocarbyl having from 1 to about 30 carbon atoms, hydroxy substituted hydrocarbyl, —(R⁶)ₙ—(R²O)_{y}R⁷, —C(═NR¹¹)NR¹²R¹³, —C(═O)NR¹²R¹³, —C(═S)NR¹²R¹³ or together with R⁵ and the nitrogen atom to which they are attached, form a cyclic or heterocyclic ring; R⁵ is hydrogen, hydrocarbyl or substituted hydrocarbyl having from 1 to about 30 carbon atoms, hydroxy substituted hydrocarbyl, —(R⁶)ₙ—(R²O)_{y}R⁷, —C(═NR¹¹)NR¹²R¹³, —C(═O)NR¹²R¹³, —C(═S)NR¹²R¹³, or together with R⁴ and the nitrogen atom to which they are attached, form a cyclic or heterocyclic ring; R⁷ is hydrogen or a linear or branched alkyl group having 1 to about 4 carbon atoms; R¹¹, R¹² and R¹³ are hydrogen, hydrocarbyl or substituted hydrocarbyl, R¹⁴ is hydrogen, hydrocarbyl or substituted hydrocarbyl having from 1 to about 30 carbon atoms, hydroxy substituted hydrocarbyl, —(R⁶)ₙ—(R²O)_{y}R⁷, —C(═NR¹¹)NR¹²R¹³, —C(═O)NR¹²R¹³, or —C(═S)NR¹²R¹³, n is 0 or 1, x and y are independently an average number from 1 to about 60, and A− is an agriculturally acceptable anion. In this context, preferred R¹, R³, R⁴, R⁵, R⁶, R¹¹, R¹² and R¹³ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. In one embodiment, R³ is linear alkylene, preferably ethylene, and R¹, R², R⁴ and R⁵ are as previously defined. In another embodiment, R⁴ is H, alkyl, or —R²OR⁷ and R¹, R², R³, R⁵ and R⁷ are as previously defined. In yet another embodiment, R¹ is a linear or branched alkyl or linear or branched alkenyl group having from about 8 to about 25 carbon atoms, R² in each of the x (R²O) groups is independently C₂-C₄ alkylene, R³ is a linear or branched alkylene group having from 1 to about 6 carbon atoms, R⁴ and R⁵ are each independently hydrogen or a linear or branched alkyl group having from 1 to about 6 carbon atoms, and x is an average number from 1 to about 30. More preferably, R¹ is a linear or branched alkyl group having from about 12 to about 22 carbon atoms, R² in each of the x (R²O) groups is independently ethylene or propylene, R³ is a linear or branched alkylene group having from 1 to about 4 carbon atoms, R⁴ and R⁵ are each independently hydrogen, methyl, or tris(hydroxymethyl)methyl, and x is an average number from about 2 to about 30. Even more preferably, R¹ is a linear or branched alkyl group having from about 12 to about 18 carbon atoms, R² in each of the x (R²O) groups is independently ethylene or propylene, R³ is an ethylene or a 2-hydroxypropylene group, R⁴ and R⁵ are each independently hydrogen or methyl, and x is an average number from about 4 to about 20. Most preferably, R¹ is a linear or branched alkyl group having from about 12 to about 18 carbon atoms, R² in each of the x (R²O) groups is independently ethylene or propylene, R³ is an ethylene or a 2-hydroxypropylene group, R⁴ and R⁵ are methyl, and x is an average number from about 4 to about 20. Compounds of formula (2) have the preferred groups as described above and R¹⁴ is preferably hydrogen or a linear or branched alkyl or alkenyl group, more preferably alkyl, and most preferably methyl. Preferred monoalkoxylated amines include PEG 13 or 18 C₁₄₋₁₅ ether propylamines and PEG 7, 10, 15 or 20 C₁₆₋₁₈ ether propylamines (from Tomah) and PEG 13 or 18 C₁₄₋₁₅ ether dimethyl propylamines and PEG 10, 15 or 20 or 25 C₁₆₋₁₈ ether dimethyl propylamines (from Tomah).

Hydroxylated amines having the formula:

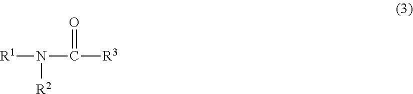

wherein R¹ is hydrocarbyl or substituted hydrocarbyl having from about 4 to about 30 carbon atoms, R² is hydrogen or hydrocarbyl or substituted hydrocarbyl having from 1 to about 30 carbon atoms, and R³ is hydroxyalkyl, polyhydroxyalkyl, or poly(hydroxyalkyl)alkyl. In this context, preferred R¹ and R² hydrocarbyl groups are linear or branched alkyl, linear or branched alkenyl, linear or branched alkynyl, aryl, or aralkyl groups. Preferably, the hydroxylated amines have the formula:

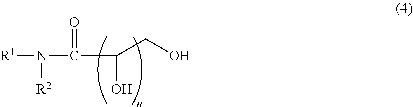

wherein R¹ is hydrocarbyl or substituted hydrocarbyl having from about 4 to about 30 carbon atoms, R² is hydrogen or hydrocarbyl or substituted hydrocarbyl having from 1 to about 30 carbon atoms, and n is 1 to about 8. In this context, preferred R¹ and R² hydrocarbyl groups are linear or branched alkyl, linear or branched alkenyl, linear or branched alkynyl, aryl, or aralkyl groups. Preferably, R¹ is a linear or branched alkyl or linear or branched alkenyl group having from about 8 to about 30 carbon atoms, R² is hydrogen, a linear or branched alkyl or linear or branched alkenyl group having from 1 to about 30 carbon atoms, and n is about 4 to about 8; or R¹ and R² are independently linear or branched alkyl or linear or branched alkenyl groups having from about 4 to about 30 carbon atoms and n is about 4 to about 8. More preferably, R¹ is a linear or branched alkyl or linear or branched alkenyl group having from about 8 to about 22 carbon atoms, R² is hydrogen or a linear or branched alkyl or linear or branched alkenyl group having from 1 to about 6 carbon atoms, and n is about 4 to about 8; or R¹ and R² are independently linear or branched alkyl or linear or branched alkenyl groups having from about 4 to about 8 carbon atoms, and n is about 4 to about 8.

Diamines having the formula:

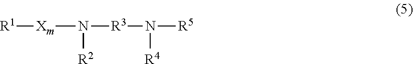

wherein R¹, R² and R⁵ are independently hydrogen or hydrocarbyl or substituted hydrocarbyl having from 1 to about 30 carbon atoms or —R⁸(OR⁹)ₙOR¹⁰, R³ is hydrocarbylene or substituted hydrocarbylene having from 2 to about 18 carbon atoms, R⁸ and R⁹ are individually hydrocarbylene or substituted hydrocarbylene having from 2 to about 4 carbon atoms, R⁴ and R¹⁰ are independently hydrogen or hydrocarbyl or substituted hydrocarbyl having from 1 to about 30 carbon atoms, m is 0 or 1, n is an average number from 0 to about 40, and X is —C(O)— or —SO₂—. In this context, preferred R¹, R², R³, R⁴, R⁵ and R¹⁰ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹, R², R⁴ and R⁵ are independently hydrogen, a linear or branched alkyl or alkenyl group having from 1 to about 6 carbon atoms, and R³ is a linear or branched alkylene having from 2 to about 6 carbon atoms. More preferably, R¹, R², R⁴ and R⁵ are independently hydrogen, or a linear or branched alkyl group having from 1 to about 6 carbon atoms, and R³ is a linear or branched alkylene having from 2 to about 6 carbon atoms. Most preferably, R¹, R², R⁴, and R⁵ are independently hydrogen or methyl, and R³ is ethylene or propylene.

Mono- or di-ammonium salts having the formula:

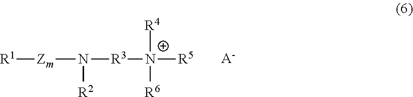

or

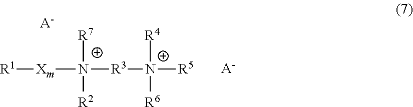

wherein R¹, R², R⁴, R⁵ and R⁷ are independently hydrogen or hydrocarbyl or substituted hydrocarbyl having from 1 to about 30 carbon atoms or —R⁸(OR⁹)ₙOR¹⁰, R⁶ is hydrocarbyl or substituted hydrocarbyl having from 1 to about 30 carbon atoms, R³ is hydrocarbylene or substituted hydrocarbylene having from 2 to about 18 carbon atoms, R⁸ and R⁹ are individually hydrocarbylene or substituted hydrocarbylene having from 2 to about 4 carbon atoms, R¹⁰ is hydrogen or hydrocarbyl or substituted hydrocarbyl having from 1 to about 30 carbon atoms, m is 0 or 1, n is an average number from 0 to about 40, X is —C(O)— or —SO₂—, Z is —C(O)—, and A⁻ is an agriculturally acceptable anion. In this context, preferred R¹-R¹⁰ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹, R², R⁴, R⁵ and R⁷ are independently hydrogen, or a linear or branched alkyl or alkenyl group having from 1 to about 6 carbon atoms, R⁶ is a linear or branched alkyl or alkenyl group having from about 8 to about 30 carbon atoms, m is 0 or 1, and R³ is a linear or branched alkylene having from 2 to about 6 carbon atoms. More preferably, R¹, R², R⁴, R⁵ and R⁷ are independently hydrogen, or a linear or branched alkyl group having from 1 to about 6 carbon atoms, R⁶ is a linear or branched alkyl group having from about 8 to about 22 carbon atoms, m is 0 or 1, and R³ is a linear or branched alkylene having from 2 to about 6 carbon atoms. Most preferably, R¹, R², R⁴, R⁵ and R⁷ are independently hydrogen or methyl, R⁶ is a linear or branched alkyl group having from about 8 to about 18 carbon atoms, m is 0 or 1, and R³ is ethylene or propylene.

Poly(hydroxyalkyl)amines having the formula:

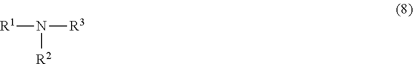

wherein R¹ is hydrocarbyl or substituted hydrocarbyl having from about 4 to about 30 carbon atoms or —R⁴OR⁵, R² is hydrogen or hydrocarbyl or substituted hydrocarbyl having from 1 to about 30 carbon atoms, R³ is hydroxyalkyl, polyhydroxyalkyl, or poly(hydroxyalkyl)alkyl, R⁴ is hydrocarbylene or substituted hydrocarbylene having from 2 to about 18 carbon atoms, and R⁵ is hydrogen or hydrocarbyl or substituted hydrocarbyl having from 1 to about 30 carbon atoms. Preferably, the poly(hydroxyalkyl)amines have the formula:

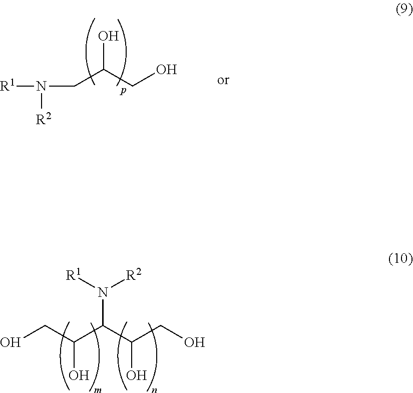

wherein R¹ is hydrocarbyl or substituted hydrocarbyl having from about 4 to about 30 carbon atoms or —R³OR⁴; R² is hydrogen or hydrocarbyl or substituted hydrocarbyl having from 1 to about 30 carbon atoms, R³ is hydrocarbylene or substituted hydrocarbylene having from 2 to about 18 carbon atoms, R⁴ is hydrogen or hydrocarbyl or substituted hydrocarbyl having from 1 to about 30 carbon atoms, m and n are independently integers from 0 to about 7, the sum of m and n is not greater than about 7, and p is an integer from 1 to about 8. In this context, preferred R¹, R², R³, and R⁴ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ is a linear or branched alkyl or linear or branched alkenyl group having from about 8 to about 30 carbon atoms or —R³OR⁴, R² is hydrogen, a linear or branched alkyl or linear or branched alkenyl group having from 1 to about 30 carbon atoms, R³ is a linear or branched alkylene or alkenylene group having from 2 to about 6 carbon atoms, R⁴ is a linear or branched alkyl or alkenyl group having from about 8 to about 22 carbon atoms, m and n are independently integers from 0 to about 7, the sum of m and n is from about 3 to 7, and p is an integer from about 4 to about 8; or R¹ and R² are independently linear or branched alkyl or linear or branched alkenyl groups having from about 4 to about 30 carbon atoms, m and n are independently integers from 0 to about 7, the sum of m and n is from about 3 to 7, and p is an integer from about 4 to about 8. More preferably, R¹ is a linear or branched alkyl or linear or branched alkenyl group having from about 8 to about 22 carbon atoms or —R³OR⁴, R² is hydrogen or a linear or branched alkyl or linear or branched alkenyl group having from 1 to about 6 carbon atoms, R³ is a linear or branched alkylene or alkenylene group having from 2 to about 6 carbon atoms, R⁴ is a linear or branched alkyl or alkenyl group having from about 8 to about 18 carbon atoms, m and n are independently integers from 0 to about 7, the sum of m and n is from about 3 to 7, and p is an integer from about 4 to about 8; or R¹ and R² are independently linear or branched alkyl or linear or branched alkenyl groups having from about 4 to about 8 carbon atoms, m and n are independently integers from 0 to about 7, the sum of m and n is from about 3 to 7, and p is an integer from about 4 to about 8. Even more preferably, R¹ is a linear or branched alkyl group having from about 8 to about 18 carbon atoms or —R³OR⁴, R² is hydrogen or methyl, m and n are independently integers from 0 to about 4, R³ is a linear or branched alkylene group having from 2 to about 6 carbon atoms, R⁴ is a linear or branched alkyl group having from about 8 to about 18 carbon atoms, the sum of m and n is about 4, and p is an integer of about 4. Most preferably, R¹ is a linear or branched alkyl group having from about 8 to about 18 carbon atoms or —R³OR⁴, R² is methyl, R³ is ethylene, propylene, hydroxyethylene or 2-hydroxypropylene, R⁴ is a linear or branched alkyl group having from about 8 to about 18 carbon atoms, m and n are independently integers from 0 to about 4, the sum of m and n is about 4, and p is an integer of about 4. Such compounds are commercially available from Aldrich and Clariant.

Alkoxylated poly(hydroxyalkyl)amines having the formula:

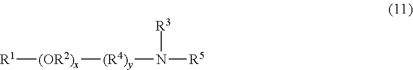

wherein R¹ and R³ are independently hydrogen, hydrocarbyl or substituted hydrocarbyl having from 1 to about 30 carbon atoms, R² in each of the x (R²O) groups is independently C₂-C₄ alkylene; R⁴ is hydrocarbylene or substituted hydrocarbylene having from 1 to about 30 carbon atoms, R⁵ is hydroxyalkyl, polyhydroxyalkyl, or poly(hydroxyalkyl)alkyl; x is an average number from 0 to about 30, and y is 0 or 1. In this context, preferred R¹, R³, and R⁴ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) group. Preferred alkoxylated poly(hydroxyalkyl)amines have the formula:

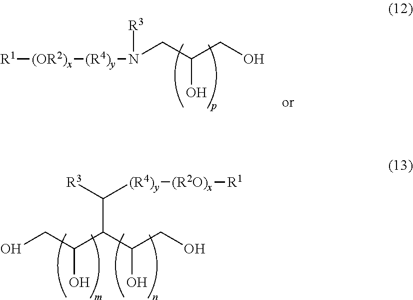

wherein R¹ and R³ are independently hydrogen, hydrocarbyl or substituted hydrocarbyl having from 1 to about 30 carbon atoms, R² in each of the x (R²O) groups is independently C₂-C₄ alkylene; R⁴ is hydrocarbylene or substituted hydrocarbylene having from 1 to about 30 carbon atoms, m and n are independently integers from 0 to about 7, the sum of m and n is not greater than about 7, p is an integer from 1 to about 8, x is an average number from 0 to about 30, and y is 0 or 1. In this context, preferred R¹, R³, and R⁴ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) group. Preferably, R¹ is a linear or branched alkyl or linear or branched alkenyl group having from about 8 to about 30 carbon atoms; R² in each of the x (R²O) groups is independently C₂-C₄ alkylene; R³ is hydrogen, a linear or branched alkyl or linear or branched alkenyl group having from 1 to about 30 carbon atoms; R¹ is a linear or branched alkylene having from 1 to about 30 carbon atoms, m and n are independently integers from 0 to about 7, the sum of m and n is from about 3 to 7, p is an integer from 1 to about 8, x is an average number from 0 to about 30, and y is 0 or 1. More preferably, R¹ is a linear or branched alkyl group having from about 8 to about 22 carbon atoms; R² in each of the x (R²O) groups is independently ethylene or propylene; R³ is hydrogen, or a linear or branched alkyl group having from 1 to about 6 carbon atoms; R⁴ is a linear or branched alkylene having from 1 to about 6 carbon atoms, m and n are independently integers from 0 to about 7, the sum of m and n is from about 3 to 7, p is an integer from 1 to about 8, x is an average number from 0 to about 30, and y is 0 or 1. Most preferably, R¹ is a linear or branched alkyl group having from about 8 to about 18 carbon atoms; R² in each of the x (R²O) groups is independently ethylene or propylene; R³ is hydrogen or methyl; m and n are independently integers from 0 to about 7, the sum of m and n is from about 3 to 7, p is an integer from 1 to about 8, x is an average number from 0 to about 30, and y is 0.

Di-poly(hydroxyalkyl)amine having the formula:

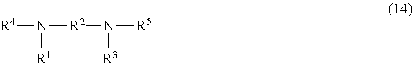

wherein R¹ and R³ are independently hydrogen or hydrocarbyl or substituted hydrocarbyl having from 1 to about 22 carbon atoms, R² is hydrocarbylene or substituted hydrocarbylene having from 2 to about 18 carbon atoms, and R⁴ and R⁵ are independently hydroxyalkyl, polyhydroxyalkyl, or poly(hydroxyalkyl)alkyl. In this context, preferred R¹, R², and R³ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, the di-poly(hydroxyalkyl)amine has the formula:

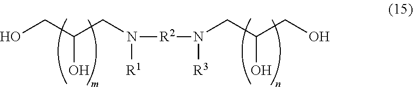

wherein R¹ and R³ are independently hydrogen or hydrocarbyl or substituted hydrocarbyl having from 1 to about 22 carbon atoms, R² is hydrocarbylene or substituted hydrocarbylene having from 2 to about 18 carbon atoms, and m and n are independently integers from 1 to about 8. In this context, preferred R¹, R², and R³ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ and R³ are independently hydrogen or a linear or branched alkyl group having from 1 to about 18 carbon atoms, R² is a linear or branched alkylene or linear or branched alkenylene group having from 2 to about 18 carbon atoms, and m and n are independently integers from 1 to about 8. More preferably, R¹ and R³ are independently hydrogen or a linear or branched alkyl group having from 6 to about 12 carbon atoms, R² is a linear or branched alkylene group having from 2 to about 6 carbon atoms, and m and n are independently integers from about 4 to about 8; or R¹ and R³ are independently hydrogen or a linear or branched alkyl group having from 1 to about 4 carbon atoms, R² is a linear or branched alkylene group having from 2 to about 16 carbon atoms, and m and n are independently integers from about 4 to about 8. Most preferably, R¹ and R³ are independently hydrogen or a linear or branched alkyl group having from 6 to about 12 carbon atoms, R² is ethylene or propylene, and m and n are independently integers from about 4 to about 8; or R¹ and R³ are independently hydrogen or a linear or branched alkyl group having from 1 to about 4 carbon atoms, R² is a linear or branched alkylene group having from 2 to about 12 carbon atoms, and m and n are independently integers from about 4 to about 8.

Quaternary poly(hydroxyalkyl)amine salts having the formula:

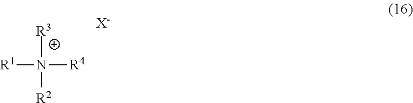

wherein R¹ is hydrocarbyl or substituted hydrocarbyl having from about 4 to about 30 carbon atoms, R² and R³ are independently hydrogen or hydrocarbyl or substituted hydrocarbyl having from 1 to about 30 carbon atoms, R; is hydroxyalkyl, polyhydroxyalkyl, or poly(hydroxyalkyl)alkyl, and X— is an agriculturally acceptable anion. In this context, preferred R¹, R², and R³ hydrocarbyl groups are linear or branched alkyl, linear or branched alkenyl, linear or branched alkynyl, aryl, or aralkyl groups. Preferably, the quaternary poly(hydroxyalkyl) amine salts have the formula:

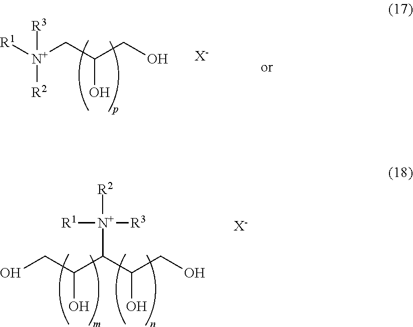

wherein R¹ is hydrocarbyl or substituted hydrocarbyl having from about 4 to about 30 carbon atoms, R² and R³ are independently hydrogen or hydrocarbyl or substituted hydrocarbyl having from 1 to about 30 carbon atoms, m and n are independently integers from 0 to about 7, the sum of m and n is not greater than about 7, p is an integer from 1 to about 8, and X— is an agriculturally acceptable anion. In this context, preferred R¹, R², and R³ hydrocarbyl groups are linear or branched alkyl, linear or branched alkenyl, linear or branched alkynyl, aryl, or aralkyl groups. Preferably, R¹ is a linear or branched alkyl or linear or branched alkenyl group having from about 8 to about 30 carbon atoms, R² and R³ are independently hydrogen or a linear or branched alkyl or linear or branched alkenyl group having from 1 to about 30 carbon atoms, m and n are independently integers from 0 to about 7, the sum of m and n is from about 3 to 7, and p is an integer from about 4 to about 8; or R¹, R² and R³ are independently linear or branched alkyl or linear or branched alkenyl groups having from about 4 to about 30 carbon atoms, m and n are independently integers from 0 to about 7, the sum of m and n is not greater than about 7, and p is an integer from about 4 to about 8. More preferably, R¹ is a linear or branched alkyl or linear or branched alkenyl group having from about 8 to about 22 carbon atoms, R² and R³ are independently hydrogen or a linear or branched alkyl or linear or branched alkenyl group having from 1 to about 6 carbon atoms, m and n are independently integers from 0 to about 7, the sum of m and n is from about 3 to 7, and p is an integer from about 4 to about 8; or R¹, R² and R³ are independently linear or branched alkyl or linear or branched alkenyl groups having from about 4 to about 8 carbon atoms, m and n are independently integers from 0 to about 7, the sum of m and n is from about 3 to 7, and p is an integer from about 4 to about 8. Even more preferably, R¹ is a linear or branched alkyl group having from about 8 to about 18 carbon atoms, R² and R³ are independently hydrogen or methyl, m and n are independently integers from 0 to about 4, the sum of m and n is about 4, and p is an integer of about 4. Most preferably, R¹ is a linear or branched alkyl group having from about 8 to about 18 carbon atoms, R² and R³ are methyl, m and n are independently integers from 0 to about 4, the sum of m and n is about 4, and p is an integer of about 4.

Triamines having the formula:

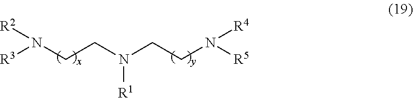

wherein R¹ is hydrocarbyl or substituted hydrocarbyl having from 1 to about 30 carbon atoms; R², R³, R⁴ and R⁵ are independently hydrogen, hydrocarbyl or substituted hydrocarbyl having from 1 to about 30 carbon atoms, or —(R⁸)ₛ(R⁷O)ₙR⁶; R⁶ is hydrogen or a linear or branched alkyl group having from 1 to about 4 carbon atoms, R⁷ in each of the n (R⁷O) groups is independently C₂-C₄ alkylene; R⁸ is hydrocarbylene or substituted hydrocarbylene having from 1 to about 6 carbon atoms, n is an average number from 1 to about 10, s is 0 or 1, and x and y are independently an integer from 1 to about 4. In this context, preferred R¹, R², R³, R⁴, R⁵, and R⁸ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ is a linear or branched alkyl or linear or branched alkenyl groups having from about 8 to about 30 carbon atoms, R², R³, R⁴ and R⁵ are independently hydrogen, a linear or branched alkyl or linear or branched alkenyl group having from 1 to about 30 carbon atoms, or —(R⁷O)ₙR⁶, R⁶ is hydrogen, methyl or ethyl; R⁷ in each of the n (R⁷O) groups is independently C₂-C₄ alkylene, n is an average number from 1 to about 10, and x and y are independently an integer from 1 to about 4. More preferably, R¹ is a linear or branched alkyl group having from about 8 to about 18 carbon atoms, R², R³, R⁴ and R⁵ are independently hydrogen, a linear or branched alkyl group having from 1 to about 6 carbon atoms, or —(R⁷O)ₙR⁶, R⁶ is hydrogen or methyl, R⁷ in each of the n (R⁷O) groups is independently ethylene or propylene, n is an average number from 1 to about 5, and x and y are independently an integer from 1 to about 4. Most preferably, R¹ is a linear or branched alkyl group having from about 8 to about 18 carbon atoms, R², R³, R⁴ and R⁵ are independently hydrogen, or —(R⁷O)ₙR⁶, R⁶ is hydrogen, R⁷ in each of the n (R⁷O) groups is independently ethylene or propylene, n is an average number from 1 to about 5, and x and y are independently an integer from 1 to about 4. Commercially available triamines include Acros and Clariant Genamin 3119.

Diamines having the formula:

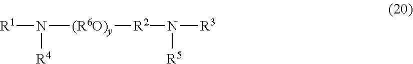

wherein R¹, R³, R⁴ and R⁵ are independently hydrogen, hydrocarbyl or substituted hydrocarbyl having from 1 to about 30 carbon atoms, or —(R⁶O)ₓR⁷, R² is hydrocarbylene or substituted hydrocarbylene having from 2 to about 30 carbon atoms, C(═NR¹¹)NR¹²R¹³—, —C(═O)NR¹²R¹³—, —C(═S)NR¹²R¹³—, —C(═NR¹²)—, —C(S)—, or —C(O)—, R⁶ in each of the x (R⁶O) and y (R⁶O) groups is independently C₂-C₄ alkylene, R⁷ is hydrogen, or a linear or branched alkyl group having from 1 to about 30 carbon atoms, R¹¹, R¹² and R¹³ are hydrogen, hydrocarbyl or substituted hydrocarbyl having from 1 to about 30 carbon atoms, x is an average number from 1 to about 50, and y is an average number from 0 to about 60. In this context, preferred R¹, R², R³, R⁴, and R⁵ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹, R³, R⁴ and R⁵ are independently hydrogen or a linear or branched alkyl or linear or branched alkenyl group having from 1 to about 22 carbon atoms or —(R⁶O)ₓR⁷, R² is a linear or branched alkylene or linear or branched alkenylene group having from 1 to about 6 carbon atoms, R⁶ in each of the x(R⁶O) and y (R⁶O) groups is independently C₂-C₄ alkylene, R⁷ is hydrogen, or a linear or branched alkyl group having from 1 to about 4 carbon atoms, x is an average number from 1 to about 30, and y is an average number from 0 to about 60. More preferably, R¹, R³, R⁴ and R⁵ are independently hydrogen or a linear or branched alkyl group having from about 1 to about 18 carbon atoms or —(R⁶O)ₓR⁷, R² is a linear or branched alkylene group having from about 1 to about 6 carbon atoms, R⁶ in each of the x (R⁶O) and y (R⁶O) groups is independently ethylene or propylene, R⁷ is hydrogen, or a linear or branched alkyl group having from 1 to about 4 carbon atoms, x is an average number from 1 to about 15, and y is an average number from 0 to about 60. Most preferably, R¹ and R³ are independently linear or branched alkyl groups having from about 8 to about 18 carbon atoms and R⁴ and R⁵ are independently hydrogen, R² is a linear or branched alkylene group having from about 1 to about 6 carbon atoms, R⁶ in each of the x (R⁶O) and y (R⁶O) groups is independently ethylene or propylene, R⁷ is hydrogen, or a linear or branched alkyl group having from 1 to about 4 carbon atoms, x is an average number from 1 to about 10, and y is an average number from 0 to about 50.

Mono- or di-quaternary ammonium salts having the formula:

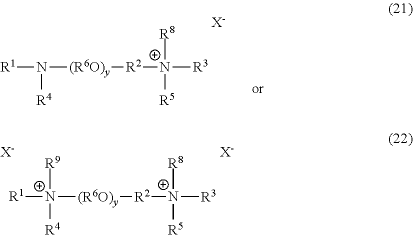

wherein R¹, R³, R⁴, R⁵, R⁸ and R⁹ are independently hydrogen, hydrocarbyl or substituted hydrocarbyl having from 1 to about 30 carbon atoms, or —(R⁶O)ₓR⁷, R² is hydrocarbylene or substituted hydrocarbylene having from 2 to about 30 carbon atoms, R⁶ in each of the x (R⁶O) and y (R⁶O) groups is independently C₂-C₄ alkylene, R⁷ is hydrogen, or a linear or branched alkyl group having from 1 to about 4 carbon atoms, x is an average number from 1 to about 30, y is an average number from about 3 to about 60, and X⁻ is an agriculturally acceptable anion. In this context, preferred R¹, R², R³, R⁴, R⁵, R⁸ and R⁹ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹, R³, R⁴, R⁵, R⁸ and R⁹ are independently hydrogen or a linear or branched alkyl or alkenyl group having from about 1 to about 22 carbon atoms or —(R⁶O)ₓR⁷, R² is a linear or branched alkylene or alkenylene group having from about 1 to about 6 carbon atoms, R⁶ in each of the x(R⁶O) and y (R⁶O) groups is independently C₂-C₄ alkylene, R⁷ is hydrogen, or a linear or branched alkyl group having from 1 to about 4 carbon atoms, x is an average number from 1 to about 30, and y is an average number from 1 to about 60. More preferably, R¹, R³, R⁴, R⁵, R⁸ and R⁹ are independently hydrogen or a linear or branched alkyl group having from about 1 to about 18 carbon atoms or —(R⁶O)ₓR⁷, R² is a linear or branched alkylene group having from about 1 to about 6 carbon atoms, R⁶ in each of the x (R⁶O) and y (R⁶O) groups is independently ethylene or propylene, R⁷ is hydrogen, or a linear or branched alkyl group having from 1 to about 4 carbon atoms, x is an average number from 1 to about 10, and y is an average number from 1 to about 60. Most preferably, R¹ and R³ are independently linear or branched alkyl groups having from about 8 to about 18 carbon atoms and R⁴, R⁵, R⁸ and R⁹ are independently hydrogen or methyl, R² is a linear or branched alkylene group having from about 1 to about 6 carbon atoms, R⁶ in each of the x (R⁶O) and y (R⁶O) groups is independently ethylene or propylene, R⁷ is hydrogen, or a linear or branched alkyl group having from 1 to about 4 carbon atoms, x is an average number from 1 to about 10, and y is an average number from 10 to about 50.

Secondary or tertiary amines having the formula:

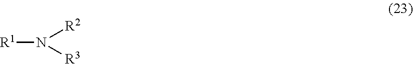

wherein R¹ and R² are hydrocarbyl having from 1 to about 30 carbon atoms, and R³ is hydrogen or hydrocarbyl having from 1 to about 30 carbon atoms. In this context, preferred R¹, R², and R³ hydrocarbyl groups are linear or branched alkyl, linear or branched alkenyl, linear or branched alkynyl, aryl, or aralkyl groups. Preferably, R¹ is a linear or branched alkyl or linear or branched alkenyl group having from about 8 to about 30 carbon atoms, and R² and R³ are independently hydrogen or a linear or branched alkyl or linear or branched alkenyl group having from 1 to about 6 carbon atoms. More preferably, R¹ is a linear or branched alkyl group having from about 12 to about 22 carbon atoms, and R² and R³ are independently hydrogen, methyl or ethyl. In one embodiment of the amine of formula (23), R¹ is a linear or branched alkyl group having from about 12 to about 22 carbon atoms, and R² and R³ are independently linear or branched hydroxyalkyl groups having from 1 to about 6 carbon atoms.

In another embodiment, the amine surfactant has the formula (23) wherein R¹ is hydrocarbyl or substituted hydrocarbyl having from about 8 to about 30 carbon atoms, R² is a hydroxyalkyl, polyhydroxyalkyl or poly(hydroxyalkyl)alkyl group, and R³ is hydrogen, hydroxyalkyl, polyhydroxyalkyl or poly(hydroxyalkyl)alkyl. In this context, preferred R¹ hydrocarbyl groups are linear or branched alkyl, linear or branched alkenyl, linear or branched alkynyl, aryl, or aralkyl groups. In one embodiment, R¹ is a linear or branched alkyl, linear or branched alkenyl, linear or branched alkynyl, aryl, or aralkyl group having from about 8 to about 30 carbon atoms, R² is a linear or branched hydroxyalkyl group having from 1 to about 6 carbon atoms, and R³ is hydrogen or a linear or branched hydroxyalkyl group having from 1 to about 6 carbon atoms. Preferably, R¹ is a linear or branched alkyl, linear or branched alkenyl, linear or branched alkynyl, aryl, or aralkyl group having from about 8 to about 22 carbon atoms, R² is a linear or branched hydroxyalkyl group having from 1 to about 4 carbon atoms, and R³ is hydrogen or a linear or branched hydroxyalkyl group having from 1 to about 4 carbon atoms. More preferably, R¹ is a linear or branched alkyl, linear or branched alkenyl, linear or branched alkynyl, aryl, or aralkyl group having from about 8 to about 18 carbon atoms, R² is hydroxymethyl or hydroxyethyl, and R³ is hydrogen, hydroxymethyl or hydroxyethyl.

Monoalkoxylated amines having the formula:

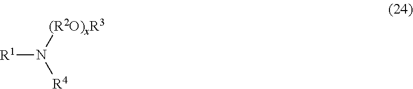

wherein R¹ and R⁴ are independently hydrocarbyl or substituted hydrocarbyl groups having from 1 to about 30 carbon atoms or —R⁵SR⁶, R² in each of the x (R²O) groups is independently C₂-C₄ alkylene, R³ is hydrogen, or a linear or branched alkyl group having from 1 to about 4 carbon atoms, R⁵ is a linear or branched alkyl group having from about 6 to about 30 carbon atoms, R⁶ is a hydrocarbyl or substituted hydrocarbyl group having from 4 to about 15 carbon atoms and x is an average number from 1 to about 60. In this context, preferred R¹, R⁴, and R⁶ hydrocarbyl groups are linear or branched alkyl, linear or branched alkenyl, linear or branched alkynyl, aryl, or aralkyl groups. In one embodiment, R¹ includes from about 7 to about 30 carbon atoms, preferably from about 8 to about 22 carbon atoms, and the remaining groups are as described above. Preferably, R¹ and R⁴ are independently a linear or branched alkyl or linear or branched alkenyl group having from 1 to about 25 carbon atoms, R² in each of the x (R²O) groups is independently C₂-C₄ alkylene, R³ is hydrogen, methyl or ethyl, and x is an average number from 1 to about 40. More preferably, R¹ and R⁴ are independently a linear or branched alkyl group having from 1 to about 22 carbon atoms, R² in each of the x (R²O) groups is independently ethylene or propylene, R³ is hydrogen or methyl, and x is an average number from 1 to about 30. Even more preferably, R¹ is a linear or branched alkyl group having from about 8 to about 22 carbon atoms and R⁴ is a linear or branched alkyl group having from 1 to about 22 carbon atoms, R² in each of the x (R²O) groups is independently ethylene or propylene, R³ is hydrogen or methyl, and x is an average number from about 1 to about 10. Most preferably, R¹ is a linear or branched alkyl group having from about 16 to about 22 carbon atoms and R⁴ is methyl, R² in each of the x (R²O) groups is ethylene, R³ is hydrogen, and x is an average number from about 1 to about 5, or R¹ is a linear or branched alkyl group having from about 8 to about 15 carbon atoms and R⁴ is methyl, R² in each of the x (R²O) groups is ethylene, R³ is hydrogen, and x is an average number from about 5 to about 10.

Dialkoxylated quaternary ammonium salts having the formula:

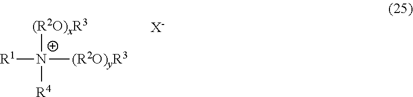

wherein R¹ is hydrocarbyl or substituted hydrocarbyl having from 1 to about 30 carbon atoms, R² in each of the x (R²O) and y (R²O) groups is independently C₂-C₄ alkylene, R³ is hydrogen, or a linear or branched alkyl group having from 1 to about 4 carbon atoms, R⁴ is hydrogen or hydrocarbyl or substituted hydrocarbyl having from 1 to about 30 carbon atoms, x and y are independently an average number from 1 to about 40, and X— is an agriculturally acceptable anion. In this context, preferred R¹ and R⁴ hydrocarbyl groups are linear or branched alkyl, linear or branched alkenyl, linear or branched alkynyl, aryl, or aralkyl groups. Preferably, R¹ and R⁴ are independently a linear or branched alkyl or linear or branched alkenyl group having from 1 to about 25 carbon atoms, R² in each of the x (R²O) and y (R²O) groups is independently C₂-C₄ alkylene, R³ is hydrogen, methyl or ethyl, and the sum of x and y is an average number from about 2 to about 30. More preferably, R¹ and R⁴ are independently a linear or branched alkyl group having from 1 to about 22 carbon atoms, R² in each of the x (R²O) and y (R²O) groups is independently ethylene or propylene, R³ is hydrogen or methyl, and the sum of x any y is an average number from about 2 to about 20. Even more preferably, R¹ is a linear or branched alkyl group having from about 8 to about 22 carbon atoms and R⁴ is a linear or branched alkyl group having from 1 to about 22 carbon atoms, R² in each of the x (R²O) and y (R²O) groups is independently ethylene or propylene, R³ is hydrogen or methyl, and x is an average number from about 2 to about 20. Most preferably, R¹ is a linear or branched alkyl group having from about 8 to about 22 carbon atoms and R⁴ is a linear or branched alkyl group having from 1 to about 6 carbon atoms, R² in each of the x (R²O) and y (R²O) groups is independently ethylene or propylene, R³ is hydrogen or methyl, and x is an average number from about 2 to about 15, or R¹ and R⁴ are independently a linear or branched alkyl group having from about 8 to about 22 carbon atoms, R² in each of the x (R²O) and y (R²O) groups is independently ethylene or propylene, R³ is hydrogen or methyl, and x is an average number from about 5 to about 15. Preferred dialkoxylated quaternary ammonium surfactants include Ethoquad™ C12 (a PEG 2 coco methyl ammonium chloride from Akzo Nobel), PEG 5 coco methyl ammonium chloride, PEG 5 tallow methyl ammonium chloride, PEG 5 ditallow ammonium bromide, and PEG 10 ditallow ammonium bromide.

Monoalkoxylated quaternary ammonium salts having the formula:

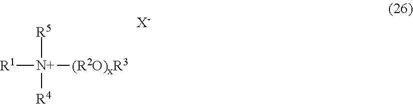

wherein R¹ and R⁵ are independently hydrogen or hydrocarbyl or substituted hydrocarbyl having from 1 to about 30 carbon atoms, R⁴ is hydrocarbyl or substituted hydrocarbyl having from 1 to about 30 carbon atoms, R² in each of the x (R²O) groups is independently C₂-C₄ alkylene, R³ is hydrogen, or a linear or branched alkyl group having from 1 to about 30 carbon atoms, x is an average number from 1 to about 60, and X— is an agriculturally acceptable anion. In this context, preferred R¹, R⁴, and R⁵ hydrocarbyl groups are linear or branched alkyl, linear or branched alkenyl, linear or branched alkynyl, aryl, or aralkyl groups. Preferably, R¹, R⁴ and R⁵ are independently a linear or branched alkyl or linear or branched alkenyl group having from 1 to about 25 carbon atoms, R² in each of the x (R²O) groups is independently C₂-C₄ alkylene, R³ is hydrogen, methyl or ethyl, and x is an average number from 1 to about 40. More preferably, R¹, R⁴ and R⁵ are independently a linear or branched alkyl group having from 1 to about 22 carbon atoms, R² in each of the x (R²O) groups is independently ethylene or propylene, R³ is hydrogen or methyl, and x is an average number from 1 to about 30. Even more preferably, R¹ is a linear or branched alkyl group having from about 8 to about 22 carbon atoms, R² in each of the x (R²O) groups is independently ethylene or propylene, R³ is hydrogen or methyl, R⁴ and R⁵ are independently a linear or branched alkyl group having from 1 to about 22 carbon atoms, and x is an average number from 1 to about 30. Even more preferably, R¹ is a linear or branched alkyl group having from about 8 to about 22 carbon atoms, R² in each of the x (R²O) groups is independently ethylene or propylene, R³ is hydrogen or methyl, R⁴ and R⁵ are independently a linear or branched alkyl group having from 1 to about 6 carbon atoms, and x is an average number from about 5 to about 25. Most preferably, R¹ is a linear or branched alkyl group having from about 16 to about 22 carbon atoms, R² in each of the x (R²O) groups is independently ethylene or propylene, R³ is hydrogen or methyl, R⁴ and R⁵ are independently a linear or branched alkyl group having from 1 to about 3 carbon atoms, and x is an average number from about 5 to about 25. Preferred monoalkoxylated quaternary ammonium surfactants include PEG 7 Cis dimethyl ammonium chloride and PEG 22 C₁₈ dimethyl ammonium chloride.

Quaternary ammonium salts having the formula:

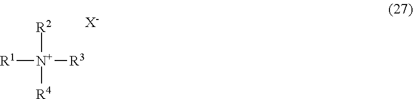

wherein R¹, R³ and R⁴ are independently hydrogen or hydrocarbyl or substituted hydrocarbyl having from 1 to about 30 carbon atoms, R² is hydrocarbyl or substituted hydrocarbyl having from 1 to about 30 carbon atoms, and X— is an agriculturally acceptable anion. In this context, preferred R¹, R², R³, and R⁴ hydrocarbyl groups are linear or branched alkyl, linear or branched alkenyl, linear or branched alkynyl, aryl, or aralkyl groups. Preferably, R¹ is a linear or branched alkyl or linear or branched alkenyl group having from about 8 to about 30 carbon atoms, and R², R³ and R⁴ are independently a linear or branched alkyl or linear or branched alkenyl group having from 1 to about 30 carbon atoms. More preferably, R¹ is a linear or branched alkyl or linear or branched alkenyl group having from about 8 to about 22 carbon atoms, and R², R³ and R⁴ are independently a linear or branched alkyl or linear or branched alkenyl group having from 1 to about 6 carbon atoms. Even more preferably, R¹ is a linear or branched alkyl group having from about 8 to about 16 carbon atoms, and R², R³ and R⁴ are independently a linear or branched alkyl group having from 1 to about 6 carbon atoms. Most preferably, R¹ is a linear or branched alkyl group having from about 8 to about 14 carbon atoms, and R², R³ and R⁴ are methyl. Preferred commercially available quaternary ammonium surfactants include Arquad™ C-50 (a dodecyl trimethyl ammonium chloride from Akzo Nobel) and Arquad™ T-50 (a tallow trimethyl ammonium chloride from Akzo Nobel).

Ether amines having the formula:

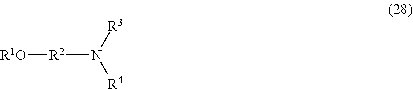

wherein R¹ is hydrocarbyl or substituted hydrocarbyl having from 1 to about 30 carbon atoms; R² is hydrocarbylene or substituted hydrocarbylene having from 2 to about 30 carbon atoms; R³ and R⁴ are independently hydrogen, hydrocarbyl or substituted hydrocarbyl having from 1 to about 30 carbon atoms, or —(R⁵O)ₓR⁶, R⁵ in each of the x(R⁵—O) groups is independently C₂-C₄ alkylene, R⁶ is hydrogen, or a linear or branched alkyl group having from 1 to about 4 carbon atoms, and x is an average number from 1 to about 50. In this context, preferred R¹, R², R³, and R⁴ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ is a linear or branched alkyl, linear or branched alkenyl, linear or branched alkynyl, aryl, or aralkyl group having from 8 to about 25 carbon atoms, R² is a linear or branched alkylene or alkenylene group having from 2 to about 30 carbon atoms, R³ and R⁴ are independently hydrogen, a linear or branched alkyl, linear or branched alkenyl, linear or branched alkynyl, aryl, or aralkyl group having from 1 to about 30 carbon atoms, or —(R⁵O)ₓR⁶, R⁵ in each of the x (R⁵O) groups is independently C₂-C₄ alkylene, R⁶ is hydrogen, methyl or ethyl, and x is an average number from 1 to about 30. More preferably, R¹ is a linear or branched alkyl or alkenyl group having from 8 to about 22 carbon atoms, R² is a linear or branched alkylene or alkenylene group having from 2 to about 6 carbon atoms, R³ and R⁴ are independently hydrogen, a linear or branched alkyl or alkenyl group having from 1 to about 6 carbon atoms, or —(R⁵O)ₓR⁶, R⁵ in each of the x (R⁵O) groups is independently ethylene or propylene, R⁶ is hydrogen or methyl, and x is an average number from 1 to about 15. Most preferably, R¹ is a linear or branched alkyl or alkenyl group having from 8 to about 18 carbon atoms, R² is ethylene or propylene, R³ and R⁴ are independently hydrogen, methyl, or —(R⁵O)ₓR⁶, R⁵ in each of the x (R⁵O) groups is independently ethylene or propylene, R⁶ is hydrogen, and x is an average number from 1 to about 5.

Diamines having the formula:

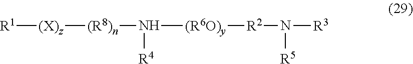

wherein R¹, R³, R¹ and R⁵ are independently hydrogen, hydrocarbyl or substituted hydrocarbyl having from 1 to about 30 carbon atoms, or —(R⁶O)ₓR⁷; R² and R⁸ are independently hydrocarbylene or substituted hydrocarbylene having from 2 to about 30 carbon atoms, R⁶ in each of the x (R⁶O) and y (R⁶O) groups is independently C₂-C₄ alkylene, R⁶ is hydrogen, or a linear or branched alkyl group having from 1 to about 30 carbon atoms, x is an average number from 1 to about 30, X is —O—, —N(R⁶)—, —C(O)—, —C(O)O—, —OC(O)—, —N(R⁹)C(O)—, —C(O)N(R⁹)—, —S—, —SO—, or —SO₂—, y is 0 or an average number from 1 to about 30, n and z are independently 0 or 1, and R⁹ is hydrogen or hydrocarbyl or substituted hydrocarbyl. In this context, preferred R¹, R², R³, R⁴, R⁵ and R⁹ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ and R⁴ are independently a linear or branched alkyl or linear or branched alkenyl group having from about 1 to about 22 carbon atoms, R² and R⁸ are independently linear or branched alkylene groups having from about 2 to about 25 carbon atoms, R³ and R⁵ are each independently hydrogen or a linear or branched alkyl group having from 1 to about 6 carbon atoms and n, y and z are 0; or R¹, R², R³ and R⁴ are independently hydrogen or a linear or branched alkyl or alkenyl group having from about 1 to about 6 carbon atoms, R² is a linear or branched alkylene or alkenylene group having from about 8 to about 25 carbon atoms, and n, y and z are 0; or R¹, R², R³ and R⁴ are independently hydrogen or a linear or branched alkyl or alkenyl group having from about 1 to about 6 carbon atoms, R² is a linear or branched alkylene or alkenylene group having from about 1 to about 6 carbon atoms, R⁶ in each of the y (R⁶O) groups is independently C₂-C₄ alkylene, y is an average number from 1 to about 20 and n and z are 0; or R¹ and R³ are independently a linear or branched alkyl or linear or branched alkenyl group having from about 8 to about 22 carbon atoms, R² is a linear or branched alkylene group having from about 2 to about 25 carbon atoms; and R⁴ and R⁵ are each independently hydrogen, a linear or branched alkyl or alkenyl group having from 1 to about 6 carbon atoms, or —(R⁶O)ₓR⁷, R⁶ in each of the x (R⁶O) groups is independently C₂-C₄ alkylene, R⁷ is hydrogen, or a linear or branched alkyl group having from 1 to about 4 carbon atoms, x is an average number from 1 to about 30, and n, y and z are 0; or R¹ is a linear or branched alkyl or linear or branched alkenyl group having from about 1 to about 22 carbon atoms, R² is a linear or branched alkylene group having from about 2 to about 25 carbon atoms, R³, R⁴ and R⁵ are each independently hydrogen or a linear or branched alkyl group having from 1 to about 6 carbon atoms, X is —C(O)— or —SO₂—, n and y are 0 and z is 1. More preferably, R¹ and R⁴ are independently a linear or branched alkyl or linear or branched alkenyl group having from about 4 to about 18 carbon atoms, R² is a linear or branched alkylene group having from about 2 to about 6 carbon atoms, R³ and R⁵ are each independently hydrogen or a linear or branched alkyl group having from 1 to about 6 carbon atoms, and n, y and z are 0; or R¹, R², R³ and R⁴ are independently hydrogen or a linear or branched alkyl group having from about 1 to about 6 carbon atoms, R² is a linear or branched alkylene group having from about 8 to about 25 carbon atoms, and y is 0; or R¹, R², R³ and R⁴ are independently hydrogen or a linear or branched alkyl group having from about 1 to about 6 carbon atoms, R² is a linear or branched alkylene group having from about 1 to about 6 carbon atoms, R⁶ in each of the y (R⁶O) groups is independently ethylene or propylene, y is an average number from 1 to about 10 and n and z is 0; or R¹ and R³ are independently a linear or branched alkyl group having from about 8 to about 22 carbon atoms, R² is a linear or branched alkylene group having from about 2 to about 6 carbon atoms, and R⁴ and R⁵ are each independently hydrogen, a linear or branched alkyl group having from 1 to about 6 carbon atoms, or —(R⁶O)ₓR⁷, R⁶ in each of the x (R⁶O) groups is independently ethylene or propylene, R⁷ is hydrogen or methyl, x is an average number from 1 to about 15, and n, y and z are 0; or R¹ is a linear or branched alkyl group having from about 1 to about 22 carbon atoms, R² is a linear or branched alkylene group having from about 2 to about 6 carbon atoms, R³, R⁴ and R⁵ are each independently hydrogen, X is —C(O)— or —SO₂—, n and y are 0 and z is 1. Preferred diamines include Gemini 14-2-14, Gemini 14-3-14, Gemini 10-2-10, Gemini 10-3-10, Gemini 10-4-10, and Gemini 16-2-16 (C₁₀, C₁₄ or C₁₆ ethylene, propylene or butylene N-methyl diamines from Monsanto), Ethoduomeens™, and Jeffamine™ EDR-148.

Amine oxides having the formula:

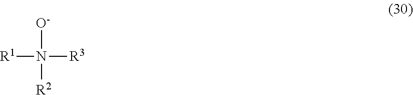

wherein R¹, R² and R³ are independently hydrogen, hydrocarbyl or substituted hydrocarbyl having from 1 to about 30 carbon atoms, —(R⁴O)ₓR⁵, or —R⁶(OR⁴)ₓOR⁵; R⁴ in each of the x (R⁴O) groups is independently C₂-C₄ alkylene, R⁵ is hydrogen, or a hydrocarbyl or substituted hydrocarbyl having from 1 to about 30 carbon atoms, R⁶ is a hydrocarbylene or substituted hydrocarbylene having from 1 to about 6 carbon atoms, x is an average number from 1 to about 50, and the total number of carbon atoms in R¹, R² and R³ is at least 8. In this context, preferred R¹, R², R³, R⁵ and R⁶ hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups. Preferably, R¹ and R² are independently hydrogen, a linear or branched alkyl or linear or branched alkenyl group having from 1 to about 30 carbon atoms, or —(R⁴O)ₓR⁵; R³ is a linear or branched alkyl or linear or branched alkenyl group having from about 8 to about 30 carbon atoms, R⁴ in each of the x (R⁴O) groups is independently C₂-C₄ alkylene; R⁵ is hydrogen or a linear or branched alkyl or linear or branched alkenyl group having from 1 to about 30 carbon atoms, and x is an average number from 1 to about 30. More preferably, R¹ and R² are independently hydrogen, or a linear or branched alkyl group having from 1 to about 6 carbon atoms, and R³ is a linear or branched alkyl group having from about 8 to about 22 carbon atoms; or R¹ and R² are independently —(R⁴O)ₓR⁵, R³ is a linear or branched alkyl group having from about 8 to about 22 carbon atoms, R⁴ in each of the x (R⁴O) groups is ethylene or propylene, R⁵ is hydrogen or a linear or branched alkyl or linear or branched alkenyl group having from 1 to about 30 carbon atoms, and x is an average number from 1 to about 10. Most preferably, R¹ and R² are independently methyl, and R³ is a linear or branched alkyl group having from about 8 to about 18 carbon atoms; or R¹ and R² are independently —(R⁴O)ₓR⁵, R³ is a linear or branched alkyl group having from about 8 to about 18 carbon atoms, R⁴ in each of the x (R⁴O) groups is ethylene or propylene, R⁵ is hydrogen or an alkyl group having from about 8 to about 18 carbon atoms, and x is an average number from 1 to about 5. Commercially available amine oxide surfactants include Chemoxide L70.

Alkoxylated amine oxides having the formula:

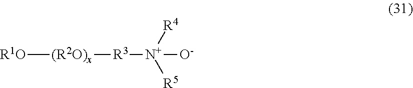

wherein R¹ is hydrogen or hydrocarbyl or substituted hydrocarbyl having from 1 to about 30 carbon atoms; R² in each of the x (R²O) and y (R²O) groups is independently C₂-C₄ alkylene; R³ is a hydrocarbylene or substituted hydrocarbylene having from 2 to about 6 carbon atoms; R⁴ and R⁵ are each independently hydrogen, hydrocarbyl or substituted hydrocarbyl having from 1 to about 30 carbon atoms, —(R⁶)ₙ—(R²O)_{y}R⁷; R⁶ is hydrocarbylene or substituted hydrocarbylene containing from 1 to about 6 carbon atoms, R⁷ is hydrogen or a linear or branched alkyl group having 1 to about 4 carbon atoms, n is 0 or 1, and x and y are independently an average number from 1 to about 60. In this context, preferred R¹, R⁴, R⁵ and R⁶ hydrocarbyl (hydrocarbylene) groups include linear or branched alkyl (alkylene), linear or branched alkenyl (alkenylene), linear or branched alkynyl (alkynylene), aryl (arylene), or aralkyl (aralkylene) groups. Preferably, R¹ is a linear or branched alkyl or linear or branched alkenyl group having from about 8 to about 25 carbon atoms, R² in each of the x (R²O) groups is independently C₂-C₄ alkylene, R³ is a linear or branched alkylene or alkenylene group having from 2 to about 6 carbon atoms, R⁴ and R⁵ are each independently hydrogen or a linear or branched alkyl group having from 1 to about 6 carbon atoms, and x is an average number from 1 to about 30. More preferably, R¹ is a linear or branched alkyl group having from about 12 to about 22 carbon atoms, R² in each of the x (R²O) groups is independently ethylene or propylene, R³ is a linear or branched alkylene or alkenylene group having from 2 to about 6 carbon atoms, R⁴ and R⁵ are each independently hydrogen, methyl, or tris(hydroxymethyl)methyl, and x is an average number from about 2 to about 30. Even more preferably, R¹ is a linear or branched alkyl group having from about 12 to about 18 carbon atoms, R² in each of the x (R²O) groups is independently ethylene or propylene, R³ is an ethylene, propylene or 2-hydroxypropylene group, R⁴ and R⁵ are each independently hydrogen or methyl, and x is an average number from about 4 to about 20. Most preferably, R¹ is a linear or branched alkyl group having from about 12 to about 18 carbon atoms, R² in each of the x (R²O) groups is independently ethylene or propylene, R³ is an ethylene, propylene, or 2-hydroxypropylene group, R⁴ and R⁵ are methyl, and x is an average number from about 4 to about 20.

Dialkoxylated amines having the formula:

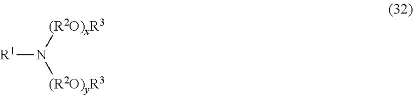

wherein R¹ is a hydrocarbyl or substituted hydrocarbyl having from about 6 to about 30 carbon atoms, or —R⁴SR⁵, R² in each of the x (R²O) and the y (R²O) groups is independently C₂-C₄ alkylene, R³ is hydrogen, or a linear or branched alkyl group having from 1 to about 4 carbon atoms, R⁴ is a linear or branched alkylene group having from about 6 to about 30 carbon atoms, R⁵ is a linear or branched alkyl group having from about 4 to about 15 carbon atoms, and x and y are independently an average number from 1 to about 40. In this context, preferred R¹ hydrocarbyl groups are linear or branched alkyl, linear or branched alkenyl, linear or branched alkynyl, aryl, or aralkyl groups. Preferably, R¹ is a linear or branched alkyl or linear or branched alkenyl group having from about 8 to about 30 carbon atoms, R² in each of the x (R²O) and the y (R²O) groups is independently C₂-C₄ alkylene, R³ is hydrogen, methyl or ethyl, and x and y are independently an average number from 1 to about 30. More preferably, R¹ is a linear or branched alkyl group having from about 8 to about 25 carbon atoms, R² in each of the x (R²O) and the y (R²O) groups is independently ethylene or propylene, R³ is hydrogen or methyl, and x and y are independently an average number from 1 to about 20. Even more preferably, R¹ is a linear or branched alkyl group having from about 8 to about 22 carbon atoms, R² in each of the x (R²O) and the y (R²O) groups is independently ethylene or propylene, R³ is hydrogen or methyl, and x and y are independently an average number from 1 to about 10 and even more preferably from 1 to about 5. Preferred commercially available dialkoxylated amines include Trymeen™ 6617 (from Cognis) and Ethomeen™ C/12, C/15, C/20, C/25, T/12, T/15, T/20 and T/25 (from Akzo Nobel).

Aminated alkoxylated alcohols having the following chemical formula:

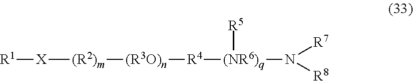

wherein R¹, R⁷, R⁸, and R⁹ are each independently hydrogen, hydrocarbyl or substituted hydrocarbyl having from 1 to about 30 carbon atoms, or —(R¹¹)ₛ(R³O)ᵥR¹⁰; X is —O—, —OC(O)—, —C(O)O—, —N(R¹²)C(O)—, —C(O)N(R¹²)—, —S—, —SO—, —SO₂— or —N(R⁹)—; R³ in each of the n (R³O) groups and the v (R³O) groups is independently C₂-C₄ alkylene; R¹⁰ is hydrogen, or a linear or branched alkyl group having from 1 to about 30 carbon atoms; n is an average number from 1 to about 60; v is an average number from 1 to about 50; R² and R¹¹ are each independently hydrocarbylene or substituted hydrocarbylene having from 1 to about 6 carbon atoms; R⁴ is hydrocarbylene or substituted hydrocarbylene having from 2 to about 6 carbon atoms; R¹² is hydrogen or hydrocarbyl or substituted hydrocarbyl having from 1 to about 30 carbon atoms; m and s are each independently 0 or 1; R⁶ is hydrocarbylene or substituted hydrocarbylene having from 2 to about 30 carbon atoms, —C(═NR¹²)—, —C(S)—, or —C(O)—; q is an integer from 0 to 5; and R⁵ is hydrogen or hydrocarbyl or substituted hydrocarbyl having from 1 to about 30 carbon atoms. In this context, preferred R¹, R², R⁴, R⁵, R⁶, R⁷, R⁸, R⁹, R¹¹ and R¹² hydrocarbyl (hydrocarbylene) groups are linear or branched alkyl (alkylene), linear or branched alkenyl (alkenylene), linear or branched alkynyl (alkynylene), aryl (arylene), or aralkyl (aralkylene) groups.

In certain embodiments, the compositions of the present invention include an additional herbicidally active component that generally may be selected from those known in the art. In certain embodiments, the active component of the composition of the present invention further comprises an active selected from the group consisting of 2,4-D, 2,4-DB, MCPA, dicamba, glufosinate, imazapic, imazapyr, imazethapyr, triclopyr, and combinations thereof. In certain embodiments, the additional herbicide is selected to enhance the residual control of the compositions of the present invention. In such embodiments, the additional herbicide may be selected from the group consisting of diflufenican, dimethenamid-P, dithiopyr, diuron, flumioxazin, flumetsulam, and isoxaflutole. The additional herbicide may also be selected from imidazolinone herbicidies such as imazapic, imazapyr, imazethapyr, and simazine; triazine herbicides such as atrazine; oxadiazole herbicides such as oxadizon; alkylazine herbicides such as indaziflam; dinitroaniline herbicides such as benefin, oryzalin, pendimethalin, prodiamine, and trifluralin; triazolinone herbicides such as sulfentrazone and thiencarbazone; triketone herbicides such as mesotrione; and combinations thereof.

In certain embodiments, the present invention may be defined by a component that it does not include. For example, as compared to other glyphosate and pelargonic acid-containing compositions known in the art, compositions of the present invention may be characterized as not including an agronomically acceptable inorganic ammonium salt selected from the group consisting of ammonium sulfate, ammonium nitrate, ammonium thiocyanate, ammonium phosphate, ammonium chloride and mixtures thereof. In addition, as noted below, the compositions of the present invention do not require pH adjustment as required in pelargonic acid+ammonium sulfate formulations, which results in simpler preparation processes for the formulations of the present invention.

The herbicidal compositions may further comprise other conventional adjuvants, excipients or additives known to those skilled in the art. These other additives or ingredients may be introduced into the compositions of the present invention to provide or improve certain desired properties or characteristics of the formulated product. Hence, the herbicidal composition may further comprise one or more additional ingredients selected from, without limitation, foam-moderating agents, preservatives or anti-microbials, antifreeze agents, solubility-enhancing agents, dyes, pH adjusters and thickening agents.

Suitable foam-moderating agents include silicone-based compositions. An example of a foam-moderating agent for RTU compositions is SAG-10, available from Momentive Performance Materials Inc. (Wilton, Conn.). The amount of foam-moderating agent optionally employed is that which is sufficient to inhibit and/or reduce an amount of foam that may otherwise be formed during the process of preparing and containerizing the formulation and/or use thereof to a desired and satisfactory level. Generally, in the case of RTU compositions, the concentration of foam-moderating agent is in the range from about 0.001% up to about 0.05% by weight of the composition, and typically from about 0.01% to about 0.03% by weight of the composition, although greater or lesser amounts may be employed.

The compositions may also comprise a preservative such as PROXEL GXL containing 1,2-benzisothiazolin-3-one (CAS No. 2634-33-5) available from Lonza (Wilmington, Del.), DOWICIL 150 containing cis-1-(3-chloroallyl)-3,5,7-triaza-1-azoniaadmatane chloride (CAS No. 051229-78-8), Kathon CG/IP, and NIPACIDE BIT20DPG containing benzisothiazolinone available from Dow Chemical Company (Midland, Mich.), LEGEND MK anti-microbial biocide available from Rohm and Haas Co. (Philadelphia, Pa.), sorbic acid, mixtures thereof and the like in the range of from about 0.01% to about 0.2% by weight, preferably about 0.1% by weight of the RTU composition. Suitable antifreeze agents include ethylene glycol and propylene glycol and generally may be present at a concentration of from about 0.1% to about 10% by weight of the RTU composition. Antifreeze agents assist in lowering the freezing point of aqueous solutions and maintaining solubility of the components of the composition such that components do not crystallize or precipitate during cycles of freezing and thawing.

Although the RTU compositions of the present invention generally show good overall stability and viscosity properties without the addition of any further additives, the addition of a solubility-enhancing agent (also commonly referred to as a cloud point enhancer or stabilizer) may significantly improve the properties of the formulations. Solubility-enhancing agents include polymer derivatives of ethylene glycol and propylene glycol (e.g., 200-1200 average molecular weight), glycerol, sugars, mixtures thereof and the like in amounts up to about 10%, preferably from about 0.05 to about 10% by weight, more preferably from about 0.1 to about 1% by weight of the RTU composition.

The herbicidal RTU compositions of the present invention can be readily prepared by simple mixing of the various components and optional ingredients in the desired quantities using a mechanical stirrer or any other suitable container or device producing the necessary amount of agitation or circulation to thoroughly mix the ingredients. The order of addition of the starting materials is not critical. For example, an herbicidal RTU composition may be formulated by first dissolving the glyphosate component, surfactant component, diquat dibromide (and optional ingredients such as biocide and antifoam) in water.

Diquat dibromide is known to decompose at pH greater than 7. Therefore, the formulations of the present invention have a pH less than 7. Generally, the components of the formulations provide such a formulation and pH adjustment is not required. This is an advantage over pelargonic acid-containing formulations that require pH monitoring and adjustment.

The formulation may be filtered (or other equivalent means employed) to remove any insoluble particulate impurities that may be present in some of the ingredients employed (e.g., commercial grades of ammonium sulfate).

The preceding description has focused primarily on aqueous RTU herbicidal compositions provided to the end-user already formulated at the desired dilution and ready for application to the foliage of unwanted plants. However, the herbicidal compositions may alternatively be prepared as application mixtures where the components are combined on site by the user, commonly referred to as a tank mixture.

Methods

The present invention is further directed to methods for killing or controlling weeds or unwanted vegetation. Such methods generally comprise applying a herbicidally effective amount of an application mixture including a composition of the present invention or a ready-to-use formulation of the present invention to the foliage of the weeds or unwanted vegetation.

The herbicidal composition of the present invention is preferably applied to plants at a rate sufficient to give both long term control of plant growth and early visual symptoms of treatment. Typically, the composition is applied at a rate sufficient to provide at least about 35%, preferably at least about 50, more preferably at least about 80% and even more preferably at least about 85% control of a treated plant species as visually measured by growth reduction or mortality 1 day after treatment, while producing visually apparent phytotoxic effects no later than about 24 hours, preferably no later than about 12 hours and more preferably no later than about 3 hours after treatment, or even no later than 1 hour after treatment. Application rates are classified as a “spray-to-wet” usually expressed as amount of composition per unit area treated (e.g., as gallons/acre or liters/m²). In the practice of the present invention, suitable long term control and earlier symptomology are generally achieved by applying the RTU composition at a spray rate of about 145 gallons/acre (0.136 liter/m²).

Such improved performance may be based on a comparison to, for example, a reference composition that does not contain the alkoxylated alcohol surfactant. See, for example, Example 2 discussed below. Improved performance has been observed based on increasing the amount of alkoxylated alcohol surfactant. See, for example, Example 1 discussed below.

### Definitions

The term “hydrocarbyl” as used herein describes organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

The term “substituted hydrocarbyl” as used herein describes hydrocarbyl moieties that are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

The term “aryl” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

The term “aralkyl” as used herein denotes a group containing both alkyl and aryl structures such as benzyl.

Unless otherwise indicated, the term “hydroxyalkyl” includes alkyl groups substituted with at least one hydroxy group, e.g., bis(hydroxyalkyl)alkyl, tris(hydroxyalkyl)alkyl and poly(hydroxyalkyl)alkyl groups. Preferred hydroxyalkyl groups include hydroxymethyl (—CH₂OH), and hydroxyethyl (—C₂H₄OH), bis(hydroxy-methyl)methyl (CH(CH₂OH)₂), and tris(hydroxymethyl)methyl (—C(CH₂OH)₃).

The term “cyclic” as used herein alone or as part of another group denotes a group having at least one closed ring, and includes alicyclic, aromatic (arene) and heterocyclic groups.

When a maximum or minimum “average number” is recited herein with reference to a structural feature such as oxyethylene units, it will be understood by those skilled in the art that the integer number of such units in individual molecules in a surfactant preparation typically varies over a range that can include integer numbers greater than the maximum or smaller than the minimum “average number.” The presence in a composition of individual surfactant molecules having an integer number of such units outside the stated range in “average number” does not remove the composition from the scope of the present invention, so long as the “average number” is within the stated range and other requirements are met.

Herbicidal effectiveness is one of the biological effects that can be enhanced through this invention. “Herbicidal effectiveness,” as used herein, refers to any observable measure of control of plant growth, which can include one or more of the actions of (1) killing, (2) inhibiting growth, reproduction or proliferation, and (3) removing, destroying, or otherwise diminishing the occurrence and activity of plants. The herbicidal effectiveness data set forth herein report “control” as a percentage following a standard procedure in the art which reflects a visual assessment of plant mortality and growth reduction by comparison with untreated plants, made by technicians specially trained to make and record such observations. In all cases, a single technician makes all assessments of percent control within any one experiment or trial.

Having described the invention in detail, it will be apparent that modifications and variations are possible without departing from the scope of the invention defined in the appended claims.

### EXAMPLES

The following non-limiting examples are provided to further illustrate the present invention.

The examples will permit better understanding of the invention and its advantages and certain variations of execution. An experimental design was performed to investigate the fast acting symptomology and weed efficacy of ready-to-use formulations containing glyphosate, diquat, and an alcohol ethoxylate surfactant. A series of formulations were prepared with varied concentrations of glyphosate, diquat, and alcohol ethoxylate surfactants. These formulations were compared to commercial lawn and garden products containing combinations of glyphosate, pelargonic acid, and diquat, as outlined below. The test was to aid in the selection of optimum levels of each component in the formulation and to investigate any interaction between the ingredients.

Formulations

In order to determine the speed at which plant destruction appeared and long term efficacy, commercial lawn and garden products (Standards) were compared with experimental aqueous herbicide formulations generated from glyphosate salt (e.g., isopropylammonium salt, GLYPH IPA), alkoxylated alcohol surfactants (SURF), diquat (DIQ), and other components (OTH) as indicated in Tables 3, 8, 13, and 30. The formulations were tested on broad spectrum lawn and garden weeds as discussed hereinafter.

Greenhouse Test and Results

Standard post emergence herbicide application procedures were used, as described below, for formulations listed in Tables 3, 8, 13, and 30.

Seeds of the plant species common purslane (CYNDA), smooth crabgrass (DIGIS), large crabgrass (DIGSA), violet crabgrass (DIGVI), goosegrass (ELEIN), ridgeseed spurge (EPHGL), spotted spurge (EPHMH), dogfennel (EUPCP), tall fescue (FESAR), annual ryegrass (LOLMG), Florida yellow woodsorrel (OXAFL), common yellow woodsorrel (OXAST), buckhorn plantain (PLALA), Kentucky bluegrass (POAPW), common purslane (POROL), St. augustinegrass (STPSW), common dandelion (TAROF), and white clover (TRFRE) were planted in 3.5 in square pots in a soil mix which was previously steam sterilized and prefertilized with a 14-14-14 Osmocote slow release fertilizer at a concentration of 3.53 g/L. The pots were placed in a greenhouse with sub-irrigation. About one week after emergence, seedlings were thinned as needed, including removal of any unhealthy or abnormal plants, to create a uniform series of test pots.

The plants were maintained for the duration of the test in the greenhouse where they received a minimum of 14 hours of light per day. If natural light was insufficient to achieve the daily requirement, artificial light with an intensity of approximately 475 microeinsteins was used to make up the difference. Exposure temperatures averaged about 29° C. during the day and about 22° C. during the night. Plants were sub-irrigated throughout the test to ensure adequate soil moisture levels.

Pots were assigned to different treatments in a randomized experimental design with 3 replications. A set of pots was left untreated as a reference against which effects of the treatments could later be evaluated. Application of tested formulations was made by spraying with a lawn and garden 24-oz trigger sprayer fitted with an RTU pump applicator calibrated to deliver a spray volume of 145 gallons per acre (GPA). After treatment, pots were returned to the greenhouse until ready for evaluation. Treatments were made using dilute aqueous compositions. Standards in the study included Roundup Concentrate Plus (6 oz/gal) and Roundup Super Concentrate (2.5 oz/gal).

For evaluation of herbicidal effectiveness, all plants in the test were examined by a single practiced technician, who recorded percent control, a visual measurement of the effectiveness of each treatment by comparison with untreated plants. Control of 0% indicates no effect, and control of 100% indicates that all of the plants are completely dead. Control of 85% or more is in most cases considered acceptable for normal herbicide use; however in greenhouse tests it is normal to apply compositions at rates which give less than 85% control, as this makes it easier to discriminate among compositions having different levels of effectiveness. The reported % control values represent the average for all replicates of each treatment.

The results of the Greenhouse Tests are summarized in Tables 4-7, 9-12, 14-29, and 31-34. The data is reported as % control (treated vs. untreated) at 3 HAT (hours after treatment), 6 HAT, 9 HAT, 1 DAT (day(s) after treatment), 3 DAT, 7 DAT, 14 DAT, 15 DAT, 22 DAT, and/or 30 DAT.

TABLE 1
Standards

| | |
|---|---|
| STD1 | ROUNDUP Concentrate Plus |
| STD2 | ROUNDUP RTU Grass & Weed |
| STD3 | ROUNDUP Extended Control RTU |
| STD4 | ROUNDUP Super Concentrate |

TABLE 2
Other Ingredients

| Code | Label | Description |
|---|---|---|
| T17 | Tomadol 1-7 | Linear alcohol ethoxylate |
| | | 7EO Undecyl alcohol |
| AC8 | Akzo C-6178 | Alkylamine ethoxylate + |
| | | alkylphosphate ester |
| AC1 | Akzo C-6221 | Alkylamine ethoxylate |
| AC0 | Akzo C-6330 | Alkylamine ethoxylate |
| PA | Pelargonic Acid | |
| SG10 | SAG 10 | Silicon antifoam emulsion |
| SG15 | SAG 1571 | Silicon antifoam emulsion |
| SUR129 | Surfonic 12-9 | Linear alcohol ethoxylate 7 |
| | | EO alcohol |
| SUR128 | Surfonic 12-8 | Linear alcohol ethoxylate 8 |
| | | EO alcohol |
| IMZ | Imazapic | |
| PG | Propylene glycol | |
| GLC | Glycerin | |
| BER | Berol 537 | Linear alcohol ethoxylate |
| | | 7EO undecyl alcohol |

### Example 1

TABLE 3

| | | | | | | | | | | | GLYPH | DIQ: |
|---|---|---|---|---|---|---|---|---|---|---|---|---|
| | | | | | | | | | | GLYPH: | IPA: | SURF |
| | GLYPH | | | | | | | DIQ | DIQ | DIQ | SURF | (wt % |
| | IPA wt | | SURF | OTH | OTH | OTH | OTH | wt % | wt % | (% ae: | (% ae: | ce: |
| CODE | (% a.e.) | SURF | wt % | 1 | 1 wt % | 2 | 2 wt % | (ai) | (ce) | % ce) | wt %) | wt % |
| STD 1 | 13.3 | T17 | 9 | | | | | 0.73 | 0.39 | 34:1 | 1.5:1 | 0.04:1 |
| STD 2 | 1.48 | | | | | PA | 2 | | | | | |
| STD 3 | 0.7 | | | IMZ | 0.017 | PA | 2 | | | | | |
| Form. 145 | 0.74 | T17 | 1 | | | | | 0.04 | 0.02 | 37:1 | 0.74:1 | 0.02:1 |
| Form. 150 | 0.74 | T17 | 2 | | | | | 0.04 | 0.02 | 37:1 | 0.37:1 | 0.01:1 |
| Form. 152 | 0.74 | T17 | 3 | | | | | 0.04 | 0.02 | 37:1 | 0.25:1 | 0.01:1 |
| Form. 153 | 0.74 | T17 | 1 | | | | | 0.08 | 0.04 | 19:1 | 0.74:1 | 0.04:1 |
| Form. 155 | 0.74 | T17 | 1 | | | | | 0.08 | 0.04 | 19:1 | 0.37:1 | 0.02:1 |
| Form. 156 | 0.74 | T17 | 3 | | | | | 0.08 | 0.04. | 19:1 | 0.25:1 | 0.01:1 |
| Form. 157 | 1.12 | T17 | 1 | | | | | 0.04 | 0.02 | 56:1 | 1.12:1 | 0.02:1 |
| Form. 159 | 1.12 | T17 | 2 | | | | | 0.04 | 0.02 | 56:1 | 0.56:1 | 0.01:1 |
| Form. 236 | 1.12 | T17 | 3 | | | | | 0.04 | 0.02 | 56:1 | 0.37:1 | 0.01:1 |
| Form. 238 | 1.12 | T17 | 2 | | | | | 0.06 | 0.03 | 37:1 | 0.56:1 | 0.02:1 |
| Form. 240 | 1.12 | T17 | 2 | | | | | 0.06 | 0.03 | 37:1 | 0.56:1 | 0.02:1 |
| Form. 241 | 1.12 | T17 | 1 | | | | | 0.08 | 0.04 | 28:1 | 1.12:1 | 0.04:1 |
| Form. 242 | 1.12 | T17 | 2 | | | | | 0.08 | 0.04 | 28:1 | 0.56:1 | 0.02:1 |
| Form. 245 | 1.12 | T17 | 3 | | | | | 0.08 | 0.04 | 28:1 | 0.37:1 | 0.01:1 |
| Form. 248 | 1.48 | T17 | 1 | | | | | 0.04 | 0.02 | 74:1 | 1.48:1 | 0.02:1 |
| Form. 249 | 1.48 | T17 | 2 | | | | | 0.04 | 0.02 | 74:1 | 0.74:1 | 0.01:1 |
| Form. 250 | 1.48 | T17 | 3 | | | | | 0.04 | 0.02 | 74:1 | 0.49:1 | 0.01:1 |
| Form. 251 | 1.48 | T17 | 1 | | | | | 0.08 | 0.04 | 37:1 | 1.48:1 | 0.04:1 |
| Form. 252 | 1.48 | T17 | 2 | | | | | 0.08 | 0.04 | 37:1 | 0.74:1 | 0.02:1 |
| Form. 254 | 1.48 | T17 | 3 | | | | | 0.08 | 0.04 | 37:1 | 0.49:1 | 0.01:1 |

### Greenhouse Test Results for Example 1

TABLE 4
POROL

| | 3 | 6 | 1 | 7 | 14 | 2 2 |
|---|---|---|---|---|---|---|
| CODE | HAT | HAT | DAT | DAT | DAT | DAT |
| STD 1 | 0 | 5 | 30 | 83.3 | 93.7 | 95.7 |
| STD 2 | 40 | 50 | 75 | 94.3 | 99 | 99.7 |
| STD 3 | 36.7 | 46.7 | 70 | 91.7 | 98.7 | 99.3 |
| Form. 145 | 5 | 10 | 40 | 90 | 97.7 | 99 |
| Form. 150 | 5 | 15 | 55 | 94 | 96.3 | 97.7 |
| Form. 152 | 10 | 23.3 | 68.3 | 95 | 97.3 | 97 |
| Form. 153 | 5 | 21.7 | 60 | 91 | 97.3 | 98.3 |
| Form. 155 | 10 | 23.3 | 71.7 | 93 | 97.3 | 98 |
| Form. 156 | 10 | 25 | 71.7 | 94 | 97.3 | 98.7 |
| Form. 157 | 5 | 6.7 | 40 | 89 | 95 | 97.7 |
| Form. 159 | 6.7 | 11.7 | 66.7 | 92.3 | 97.3 | 99 |
| Form. 236 | 10 | 18.3 | 66.7 | 93.3 | 97.3 | 98.7 |
| Form. 238 | 15 | 25 | 71.7 | 93 | 97.3 | 99.3 |
| Form. 240 | 10 | 21.7 | 70 | 94 | 99 | 99.7 |
| Form. 241 | 5 | 6.7 | 46.7 | 91.3 | 97 | 98 |
| Form. 242 | 10 | 21.7 | 68.3 | 94.3 | 98.7 | 99 |
| Form. 245 | 13.3 | 25 | 73.3 | 94.7 | 97.7 | 99.7 |
| Form. 248 | 5 | 5 | 40 | 93.3 | 97.7 | 99.7 |
| Form. 249 | 6.7 | 15 | 66.7 | 93.7 | 97.3 | 100 |
| Form. 250 | 11.7 | 21.7 | 70 | 95.3 | 97.7 | 100 |
| Form. 251 | 5 | 6.7 | 60 | 94.7 | 98.7 | 100 |
| Form. 252 | 5 | 10 | 60 | 93.3 | 98 | 99.7 |
| Form. 254 | 8.3 | 25 | 66.7 | 95 | 98 | 99.7 |

TABLE 5
TRFRE

| | 3 | 6 | 1 | 7 | 14 | 22 |
|---|---|---|---|---|---|---|
| CODE | HAT | HAT | DAT | DAT | DAT | DAT |
| STD 1 | 5 | 5 | 16.7 | 68.3 | 75 | 70 |
| STD 2 | 45 | 48.3 | 75 | 81.7 | 83.3 | 81.7 |
| STD 3 | 45 | 48.3 | 75 | 81.7 | 83.3 | 80 |
| Form. 145 | 20 | 25 | 45 | 68.3 | 76.7 | 75 |
| Form. 150 | 20 | 21.7 | 55 | 86.7 | 88 | 90 |
| Form. 152 | 20 | 26.7 | 56.7 | 84.3 | 87.7 | 88.3 |
| Form. 153 | 20 | 23.3 | 66.7 | 89.3 | 89.3 | 90.7 |
| Form. 155 | 20 | 26.7 | 63.3 | 91 | 90.3 | 91.3 |
| Form. 156 | 20 | 25 | 65 | 86.3 | 90.3 | 90.3 |
| Form. 157 | 18.3 | 20 | 41.7 | 80 | 80 | 78.3 |
| Form. 159 | 23.3 | 25 | 56.7 | 83.3 | 83.3 | 86 |
| Form. 236 | 21.7 | 25 | 61.7 | 82.7 | 86 | 86.3 |
| Form. 238 | 20 | 23.3 | 65 | 87.3 | 92 | 94 |
| Form. 240 | 23.3 | 25 | 65 | 90.3 | 92.3 | 92.3 |
| Form. 241 | 20 | 21.7 | 58.3 | 88.3 | 88.3 | 88 |
| Form. 242 | 20 | 23.3 | 55 | 89.7 | 91.7 | 90.7 |
| Form. 245 | 23.3 | 23.3 | 66.7 | 86.3 | 85 | 84 |
| Form. 248 | 18.3 | 23.3 | 50 | 81.7 | 82.7 | 84.3 |
| Form. 249 | 21.7 | 26.7 | 65 | 85.3 | 88 | 90 |
| Form. 250 | 25 | 26.7 | 63.3 | 89.3 | 93 | 94.3 |
| Form. 251 | 20 | 20 | 56.7 | 92 | 92.7 | 92.7 |
| Form. 252 | 23.3 | 25 | 60 | 89 | 92.3 | 93.3 |
| Form. 254 | 25 | 25 | 65 | 90.7 | 96 | 96 |

TABLE 6
FEASAR

| | 3 | 6 | 1 | 7 | 14 | 22 |
|---|---|---|---|---|---|---|
| CODE | HAT | HAT | DAT | DAT | DAT | DAT |
| STD 1 | 0 | 0 | 10 | 56.7 | 83.3 | 94.3 |
| STD 2 | 8.3 | 13.3 | 35 | 78.3 | 94.7 | 99 |
| STD 3 | 8.3 | 8.3 | 31.7 | 76.7 | 94.3 | 98 |
| Form. 145 | 0 | 5 | 15 | 58.3 | 86.7 | 97.3 |
| Form. 150 | 3.3 | 5 | 25 | 75 | 90 | 96 |
| Form. 152 | 0 | 1.7 | 26.7 | 75 | 88.7 | 94.3 |
| Form. 153 | 1.7 | 6.7 | 31.7 | 86 | 93.3 | 95 |
| Form. 155 | 5 | 6.7 | 35 | 81 | 89 | 95 |
| Form. 156 | 3.3 | 5 | 35 | 85.3 | 93 | 95.7 |
| Form. 157 | 3.3 | 5 | 23.3 | 68.3 | 91 | 96.7 |
| Form. 159 | 0 | 5 | 13.3 | 58.3 | 83.3 | 93.3 |
| Form. 236 | 5 | 5 | 21.7 | 73.3 | 90.7 | 93 |
| Form. 238 | 5 | 5 | 28.3 | 81.7 | 94.7 | 96.7 |
| Form. 240 | 5 | 5 | 25 | 78.3 | 92.7 | 95.3 |
| Form. 241 | 1.7 | 3.3 | 21.7 | 75 | 91.3 | 95.7 |
| Form. 242 | 5 | 5 | 26.7 | 84.3 | 92.3 | 96 |
| Form. 245 | 5 | 5 | 33.3 | 84.3 | 93.3 | 94.7 |
| Form. 248 | 0 | 1.7 | 16.7 | 81.7 | 94 | 97 |
| Form. 249 | 5 | 5 | 21.7 | 88.3 | 93.7 | 95.7 |
| Form. 250 | 5 | 5 | 23.3 | 79.7 | 95.3 | 96.7 |
| Form. 251 | 5 | 5 | 26.7 | 85 | 95 | 97.7 |
| Form. 252 | 5 | 5 | 30 | 86 | 94.7 | 97 |
| Form. 254 | 5 | 5 | 23.3 | 91.3 | 96.3 | 97.7 |

TABLE 7
DIGSA

| | 3 | 6 | 1 | 7 | 14 | 22 |
|---|---|---|---|---|---|---|
| CODE | HAT | HAT | DAT | DAT | DAT | DAT |
| STD 1 | 0 | 5 | 25 | 88.7 | 94 | 97 |
| STD 2 | 25 | 40 | 85 | 98.3 | 98.7 | 100 |
| STD 3 | 25 | 38.3 | 75 | 93.7 | 95.3 | 98 |
| Form. 145 | 11.7 | 15 | 58.3 | 93.7 | 98.3 | 98.3 |
| Form. 150 | 11.7 | 16.7 | 61.7 | 97 | 98.3 | 99 |
| Form. 152 | 10 | 25 | 66.7 | 96 | 97.7 | 98 |
| Form. 153 | 5 | 16.7 | 56.7 | 97.3 | 97.7 | 98 |
| Form. 155 | 10 | 20 | 65 | 97.7 | 98 | 98 |
| Form. 156 | 11.7 | 25 | 68.3 | 99 | 99 | 100 |
| Form. 157 | 5 | 18.3 | 60 | 98 | 97 | 99 |
| Form. 159 | 11.7 | 18.3 | 58.3 | 95.7 | 97.3 | 98.3 |
| Form. 236 | 10 | 18.3 | 68.3 | 98.7 | 98.7 | 99.3 |
| Form. 238 | 10 | 15 | 53.3 | 95.3 | 97 | 97.7 |
| Form. 240 | 10 | 20 | 66.7 | 98.7 | 98.7 | 99.3 |
| Form. 241 | 5 | 16.7 | 65 | 96.7 | 98 | 99 |
| Form. 242 | 10 | 16.7 | 63.3 | 97.7 | 98.7 | 99 |
| Form. 245 | 10 | 23.3 | 66.7 | 99 | 99 | 100 |
| Form. 248 | 5 | 6.7 | 55 | 98.7 | 98.7 | 99.7 |
| Form. 249 | 10 | 15 | 56.7 | 99 | 99 | 100 |
| Form. 250 | 10 | 16.7 | 68.3 | 98.7 | 98.7 | 100 |
| Form. 251 | 8.3 | 15 | 65 | 98.7 | 98.7 | 100 |
| Form. 252 | 10 | 15 | 61.7 | 98.7 | 98.7 | 99.7 |
| Form. 254 | 11.7 | 18.3 | 66.7 | 98.7 | 99 | 100 |

Discussion

Example 1 demonstrates that increased levels of alcohol ethoxylate surfactant can provide increased level of control, particularly for POROL. Additionally, formulations containing increased levels of diquat may exhibit lower levels of control.

It can be observed that increased surfactant amounts provide greater POROL control. For example, see Formulation 145 (1 wt %) as compared to Formulation 150 (2 wt %) and Formulation 152 (3 wt %). In some formulations a 2 wt % alcohol ethoxylate surfactant formulation may provide comparable levels of control as compared to a 3 wt % alcohol ethoxylate surfactant formulation. However, in each test formulation, 2 wt % or 3 wt % alcohol ethoxylate surfactant provided noticeable control improvement over a 1 wt % formulation.

While test formulations generally provided less control at a given time period as compared to the standard formulations containing pelargonic acid (STD 2 and STD 3), specifically at 3 HAT and 6 HAT, the test formulation containing no pelargonic acid (STD 1) also provided less control. Few differences in weed control were observed among test candidates at 7, 14, and 22 DAT. Overall control at 22 DAT was high for all formulations. However, STD 1 provided some of the lowest control over all time periods. This can be acutely observed with respect to TRFRE at 22 DAT.

For formulations where it is desirable to exclude pelargonic acid, the use of glyphosate, an alcohol ethoxylate surfactant, and low amounts of diquat greatly increase the speed and efficacy of plant death as compared to formulations containing higher amounts of diquat.

### Example 2

TABLE 8

| | | | | | | | | | | | GLYPH | DIQ: |
|---|---|---|---|---|---|---|---|---|---|---|---|---|
| | GLYPH | | | | | | | | | GLYPH: | IPA: | SURF |
| | IPA | | | | | | | DIQ | DIQ | DIQ | SURF | (wt % |
| | wt (% | | SURF | OTH | OTH | OTH | OTH | wt % | wt % | (% ae: | (% ae: | ce: |
| CODE | a.e.) | SURF | wt % | 1 | 1 wt % | 2 | 2 wt % | (ai) | (ce) | % ce) | wt %) | wt %) |
| STD 1 | 13.3 | T17 | 9 | | | | | 0.73 | 0.39 | 34:1 | 1.48:1 | 0.043:1 |
| STD 4 | 37.1 | | | | | | | | | | | |
| STD 2 | 1.48 | | | | | PA | 2 | | | | | |
| STD 3 | 0.74 | | | IMZ | 0.017 | PA | 2 | 0.74 | 0.40 | 1.9:1 | | |
| Form. 520-A | 0.74 | T17 | 1.5 | | | | | 0.08 | 0.04 | 17.3:1 | 0.49:1 | 0.029:1 |
| Form. 520-B | 0.74 | T17 | 2 | | | | | 0.08 | 0.04 | 17.3:1 | 0.37:1 | 0.021:1 |
| Form. 520-C | 0.74 | T17 | | | | | | 0.08 | 0.04 | 17.3:1 | 0.74:1 | 0.043:1 |
| Form. 520-D | 0.74 | T17 | 0 | | | | | 0.08 | 0.04 | 17.3:1 | No SURF | |
| Form. 520-E | 0.74 | T17 | 1.5 | | | | | 0.04 | 0.02 | 34.5:1 | 0.49:1 | 0.014:1 |
| Form. 520-F | 0.74 | T17 | 2 | | | | | 0.04 | 0.02 | 34.5:1 | 0.37:1 | 0.011:1 |
| Form. 520-G | 0.74 | T17 | 1 | | | | | 0.04 | 0.02 | 34.5:1 | 0.74:1 | 0.021:1 |
| Form. 520-H | 0.74 | T17 | 0 | | | | | 0.04 | 0.02 | 34.5:1 | No SURF | |
| Form. 428 | 0.74 | T17 | 1 | IMZ | 0.017 | PA | 2 | | | | 0.74:1 | |
| Form. 419 | 0.74 | T17 | 1.5 | IMZ | 0.017 | PA | 2 | | | | 0.49:1 | |
| Form. 429 | 0.74 | T17 | 2 | IMZ | 0.017 | PA | 2 | | | | 0.37:1 | |
| Form. 430 | 0.74 | T17 | 3 | IMZ | 0.017 | PA | 2 | | | | 0.25:1 | |

### Greenhouse Test Results for Example 2

TABLE 9
POROL

| | 3 | 6 | 1 | 7 | 14 | 22 |
|---|---|---|---|---|---|---|
| Code | HAT | HAT | DAT | DAT | DAT | DAT |
| STD 1 | 5 | 20 | 36.7 | 91 | 96.7 | 97.3 |
| STD 4 | 0 | 0 | 20 | 94.7 | 100 | 100 |
| STD 2 | 80 | 92.7 | 95 | 98.7 | 99.3 | 100 |
| STD 3 | 80 | 90 | 95 | 99 | 99.3 | 100 |
| Form. 520-A | 56.7 | 73.3 | 91.3 | 97.7 | 99 | 99.7 |
| Form. 520-B | 58.3 | 75 | 91 | 98.3 | 98.3 | 99.7 |
| Form. 520-C | 31.7 | 61.7 | 81.7 | 96.3 | 98.3 | 99 |
| Form. 520-D | 0 | 5 | 16.7 | 94 | 99.3 | 99.7 |
| Form. 520-E | 45 | 70 | 83.3 | 96.7 | 97.3 | 99 |
| Form. 520-F | 60 | 78.3 | 93.3 | 97.7 | 98.3 | 98.7 |
| Form. 520-G | 35 | 66.7 | 83.3 | 93.7 | 95.3 | 98 |
| Form. 520-H | 0 | 1.7 | 15 | 81.7 | 93.7 | 97.7 |
| Form. 428 | 66.7 | 78.3 | 92.3 | 98.3 | 99.3 | 99.3 |
| Form. 419 | 68.3 | 83.3 | 94.7 | 98.7 | 99.3 | 99.7 |
| Form. 429 | 73.3 | 86.3 | 95 | 99 | 99.7 | 99.7 |
| Form. 430 | 73.3 | 84.3 | 95 | 99 | 100 | 100 |
| UNTREATED | 0 | 0 | 0 | 0 | 0 | 0 |

TABLE 10
TRFRE

| | 3 | 6 | 1 | 7 | 14 | 22 |
|---|---|---|---|---|---|---|
| Code | HAT | HAT | DAT | DAT | DAT | DAT |
| STD 1 | 25 | 38.3 | 53.3 | 88.7 | 91.7 | 91 |
| STD 4 | 0 | 5 | 15 | 89.3 | 98.3 | 99 |
| STD 2 | 78.3 | 84.3 | 88.7 | 92.3 | 96 | 96.7 |
| STD 3 | 85 | 87 | 92.7 | 94 | 95.3 | 96.3 |
| Form. 520-A | 65 | 70 | 84.3 | 98.3 | 99 | 98.7 |
| Form. 520-B | 63.3 | 71.7 | 86 | 98 | 99 | 99.3 |
| Form. 520-C | 46.7 | 75 | 83.3 | 98.7 | 99 | 99.7 |
| Form. 520-D | 0 | 10 | 33.3 | 93.3 | 96.7 | 98.3 |
| Form. 520-E | 61.7 | 73.3 | 76.7 | 96.7 | 98.3 | 99 |
| Form. 520-F | 63.3 | 73.3 | 85 | 98 | 98.3 | 98.3 |
| Form. 520-G | 50 | 70 | 86 | 97.7 | 99.3 | 100 |
| Form. 520-H | 0 | 5 | 20 | 81.7 | 90 | 93.3 |
| Form. 428 | 76.7 | 87.3 | 92.7 | 95.7 | 98 | 98.3 |
| Form. 419 | 78.3 | 87.3 | 93.3 | 96 | 97 | 98 |
| Form. 429 | 80 | 86.7 | 93.3 | 95.3 | 96.7 | 97 |
| Form. 430 | 76.7 | 81.7 | 92.7 | 96 | 98 | 98.3 |
| UNTREATED | 0 | 0 | 0 | 0 | 0 | 0 |

TABLE 11
FESARR

| | 3 | 6 | 1 | 7 | 14 | 22 |
|---|---|---|---|---|---|---|
| Code | HAT | HAT | DAT | DAT | DAT | DAT |
| STD 1 | 0 | 10 | 30 | 80 | 92.7 | 97.3 |
| STD 4 | 0 | 1.7 | 1.7 | 58.3 | 97 | 99 |
| STD 2 | 38.3 | 55 | 80 | 94.7 | 97.7 | 99 |
| STD 3 | 36.7 | 55 | 82.7 | 96.7 | 99 | 99.3 |
| Form. 520-A | 21.7 | 31.7 | 58.3 | 94.3 | 97.7 | 99 |
| Form. 520-B | 20 | 35 | 55 | 96.3 | 98.3 | 99.3 |
| Form. 520-C | 16.7 | 28.3 | 48.3 | 91.3 | 95 | 99 |
| Form. 520-D | 0 | 1.7 | 10 | 80 | 96.3 | 99 |
| Form. 520-E | 21.7 | 30 | 51.7 | 94.3 | 97 | 99 |
| Form. 520-F | 18.3 | 31.7 | 53.3 | 93.7 | 97 | 99 |
| Form. 520-G- | 16.7 | 23.3 | 53.3 | 91.7 | 96.7 | 99 |
| Form. 520-H | 0 | 1.7 | 8.3 | 66.7 | 92 | 98.7 |
| Form. 428 | 31.7 | 43.3 | 73.3 | 94.7 | 98 | 99 |
| Form. 419 | 40 | 53.3 | 76.7 | 96.7 | 99 | 99 |
| Form. 429 | 33.3 | 40 | 81 | 97.7 | 99 | 99 |
| Form. 430 | 36.7 | 40 | 70 | 96 | 98 | 99 |
| UNTREATED | 0 | 0 | 0 | 0 | 0 | 0 |

TABLE 12
DIGSA

| | 3 | 6 | 1 | 7 | 14 | 22 |
|---|---|---|---|---|---|---|
| Code | HAT | HAT | DAT | DAT | DAT | DAT |
| STD 1 | 5 | 40 | 70 | 94.3 | 97 | 98.3 |
| STD 4 | 0 | 5 | 10 | 98 | 99.7 | 100 |
| STD 2 | 71.7 | 95 | 97 | 99 | 99.7 | 100 |
| STD 3 | 71.7 | 88.3 | 97.3 | 99 | 99.7 | 99.7 |
| Form. 520-A | 40 | 70 | 93.7 | 98.3 | 99.7 | 99.7 |
| Form. 520-B | 50 | 78.3 | 94.3 | 99 | 100 | 100 |
| Form. 520-C | 48.3 | 78.3 | 93 | 99 | 100 | 100 |
| Form. 520-D | 0 | 6.7 | 43.3 | 94 | 98 | 99 |
| Form. 520-E | 48.3 | 81.7 | 94.7 | 99 | 99.7 | 99.7 |
| Form. 520-F | 40 | 73.3 | 93.7 | 99 | 100 | 100 |
| Form. 520-G- | 45 | 76.7 | 94.3 | 98.3 | 99.3 | 99.7 |
| Form. 520-H | 0 | 6.7 | 36.7 | 98.3 | 99.3 | 99.3 |
| Form. 428 | 45 | 78.3 | 96 | 99 | 99.3 | 100 |
| Form. 419 | 50 | 81.7 | 97.3 | 99 | 99.3 | 100 |
| Form. 429 | 56.7 | 86 | 96.7 | 99 | 99.3 | 99.3 |
| Form. 430 | 60 | 88.7 | 97 | 99 | 99.7 | 100 |
| UNTREATED | 0 | 0 | 0 | 0 | 0 | 0 |

Discussion

Example 2 demonstrates that improvements in symptomology speed and efficacy are observed when both an alcohol ethoxylate surfactant and diquat are used in a glyphosate formulation. Additionally, higher surfactant concentrations in the formulation have been observed to further increase the symptomology speed and overall efficacy.

Test formulations containing higher alcohol ethoxylate surfactant amounts relative to the same amount of diquat provided higher control. For example, see Formulation 520-B (2 wt % SURF) as compared to Formulation 520-A (1.5 wt % SURF) and Formulation 520-C (1 wt % SURF); also see Formulation 520-F (2 wt % SURF) as compared to Formulation 520-E (1.5 wt % SURF) and Formulation 520-G (1 wt % SURF).

Additionally, formulations in which diquat was present but where no alcohol ethoxylate surfactant was present (Formulation 520-D and Formulation 520-H) reported a greatly reduced overall weed control and symptomology speed. Comparing Formulation 520-D and Formulation 520-H to identical formulations containing only the additional ingredient of an alcohol ethoxylate surfactant, it can observe that the use of diquat in combination with an alcohol ethoxylate surfactant, in a glyphosate formulation, provides considerable improvements in symptomology speed as compared to a glyphosate formulation containing only diquat.

Test formulations generally provided less control at 3 and 6 HAT as compared to the standard formulations containing pelargonic acid (STD 2, STD 3, Formulation 428, Formulation 419, Formulation 429, and Formulation 430). However, standard formulations containing no pelargonic acid (STD 1 and STD 4) also provided lower control than the test formulations. Therefore, where it is desirable to exclude pelargonic acid, the use of diquat and an alcohol ethoxylate surfactant in a glyphosate formulation provides improved symptomology speed and efficacy over glyphosate formulations containing only diquat.

### Example 3

TABLE 13

| | | | | | | | | | | | GLYPH | DIQ: | |
|---|---|---|---|---|---|---|---|---|---|---|---|---|---|
| | | | | | | | | | | GLYPH: | IPA: | SURF | |
| | GLYPH | | | | OTH 1 | | | DIQ | DIQ | DIQ | SURF | (wt % | |
| | IPA wt | | SURF | OTH | wt % | OTH | OTH 2 | wt % | wt % | (% ae: | (% ae: | ce: | pH |
| Code | (% ae) | SURF | wt % | 1 | (% a.i.) | 2 | wt % | (% ce) | (% ce) | % ce) | wt %) | wt %) | (neat) |
| Form. 126 | 0.74 | AC0 | 0.3 | IMZ | 0.017 | PA | 2 | | | | 2.47:1 | | 7.4 |
| Form. 911 | 0.82 | T17 | 2 | | | | | 0.068 | 0.04 | 21:1 | 0.41:1 | 0.02:1 | |
| Form. 912 | 0.74 | T17 | 1.5 | | | | | 0.04 | 0.02 | 37:1 | 0.49:1 | 0.01:1 | |
| Form. 913 | 0.74 | T17 | 2 | IMZ | 0.08 | | | 0.04 | 0.021 | 35:1 | 0.37:1 | 0.01:1 | |
| Form. 914 | 0.74 | T17 | 1.5 | IMZ | 0.08 | | | 0.08 | 0.043 | 17:1 | 0.49:1 | 0.03:1 | 4.5 |
| Form. 915 | 0.74 | T17 | 2 | IMZ | 0.08 | | | 0.08 | 0.043 | 17:1 | 0.37:1 | 0.02:1 | 4.49 |
| Form. 919 | 0.74 | T17 | 2 | INV | 0.017 | | | 0.04 | 0.021 | 35:1 | 0.37:1 | 0.01:1 | 4.51 |
| Form. 921 | 0.74 | T17 | 2 | IMZ | 0.017 | | | 0.08 | 0.043 | 17:1 | 0.37:1 | 0.02:1 | |
| Form. 973 | 0.74 | T17 | 2 | INV | 0.017 | | | 0.04 | 0.021 | 35:1 | 0.37:1 | 0.01:1 | |
| Form. 978 | 0.74 | AC0 | 0.5 | IMZ | 0.017 | | | 0.08 | 0.043 | 17:1 | 0.09:1 | 0.09:1 | 5.3 |

### Greenhouse Test Results for Example 3

TABLE 14
CYNDA

| | 3 | 6 | 1 | 7 |
|---|---|---|---|---|
| | HAT | HAT | DAT | DAT |
| ROUNDUP W&G RTU | 16.7 | 18.3 | 18.3 | 80 |
| PLUS | | | | |
| Form. 126 | 11.7 | 15 | 16.7 | 80 |
| Form. 978 | 0 | 5 | 13.3 | 90 |
| Form. 973 | 5 | 5 | 16.7 | 93.3 |
| Form. 921 | 11.7 | 5 | 18.3 | 95 |
| ROUNDUP EXTND | 0 | 0 | 5 | 90 |
| CTRL CONC | | | | |

TABLE 15
DIGIS

| | 3 | 6 | 9 | 1 | 7 | 15 | 30 |
|---|---|---|---|---|---|---|---|
| Code | HAT | HAT | HAT | DAT | DAT | DAT | DAT |
| ROUNDUP W&G | 26.7 | 30 | 30 | 35 | 98.3 | 100 | 100 |
| RTU PLUS | | | | | | | |
| Form. 126 | 28.3 | 35 | 36.7 | 20 | 100 | 100 | 100 |
| Form. 978 | 11.7 | 10 | 11.7 | 16.7 | 98.3 | 100 | 100 |
| Form. 973 | 6.7 | 13.3 | 15 | 20 | 100 | 100 | 100 |
| Form. 921 | 13.3 | 20 | 23.3 | 28.3 | 96.7 | 100 | 100 |
| ROUNDUP EXTND | 1.7 | 3.3 | 3.3 | 6.7 | 100 | 100 | 100 |
| CTRL CONC | | | | | | | |

TABLE 16
DIGSA

| | 3 | 6 | 1 | 7 | 15 | 30 |
|---|---|---|---|---|---|---|
| Code | HAT | HAT | DAT | DAT | DAT | DAT |
| ROUNDUP W&G | 60.6 | 74.4 | 77.4 | 88.1 | 99 | 92.6 |
| RTU PLUS | | | | | | |
| Form. 126 | 64.2 | 75.7 | 75.1 | 97.2 | 89.1 | 91.9 |
| Form. 978 | 40.4 | 55 | 74.8 | 87.6 | 88.1 | 95.6 |
| Form. 973 | 42.1 | 58.8 | 75.4 | 96.6 | 86.2 | 88.8 |
| Form. 921 | 50.8 | 60.2 | 84.9 | 88.7 | 99.2 | 91.5 |
| ROUNDUP EXTND | 22.3 | 31.7 | 36.9 | 83.9 | 88.8 | 91.1 |
| CTRL CONC | | | | | | |

TABLE 17
DIGVI

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 41.7 | 78.3 | 80 | 81.7 | 98.3 | 100 | 88.3 |
| RTU PLUS | | | | | | | |
| Form. 126 | 46.7 | 81.7 | 81.7 | 83.3 | 98.3 | 98.3 | 86.7 |
| Form. 978 | 11.7 | 23.3 | 23.3 | 31.7 | 98.3 | 100 | 90 |
| Form. 973 | 15 | 51.7 | 56.7 | 66.7 | 100 | 100 | 81.7 |
| Form. 921 | 20 | 56.7 | 60 | 71.7 | 96.7 | 100 | 93.3 |
| ROUNDUP EXTND | 1.7 | 6.7 | 6.7 | 10 | 98.3 | 100 | 88.3 |
| CTRL CONC | | | | | | | |

TABLE 18
ELEIN

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 23.3 | 73.3 | 73.3 | 73.3 | 98 | 99.7 | 100 |
| RTU PLUS | | | | | | | |
| Form. 126 | 26.7 | 80 | 80 | 80 | 96.7 | 99.3 | 100 |
| Form. 978 | 10 | 76.7 | 80 | 91.7 | 95 | 97.7 | 100 |
| Form. 973 | 16.7 | 86.7 | 86.7 | 95.7 | 99 | 100 | 100 |
| Form. 921 | 40 | 95 | 97 | 99 | 100 | 100 | 100 |
| ROUNDUP EXTND | 5 | 13.3 | 23.3 | 30 | 98 | 100 | 100 |
| CTRL CONC | | | | | | | |

TABLE 19
EPHGL

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 20 | 91.7 | 91.7 | 90 | 100 | 100 | 100 |
| RTU PLUS | | | | | | | |
| Form. 126 | 23.3 | 91.7 | 91.7 | 94.3 | 100 | 100 | 100 |
| Form. 978 | 23.3 | 83.3 | 83.3 | 95 | 100 | 100 | 100 |
| Form. 973 | 53.3 | 100 | 100 | 100 | 100 | 100 | 100 |
| Form. 921 | 56.7 | 100 | 100 | 100 | 100 | 100 | 100 |
| ROUNDUP EXTND | | | | | | | |
| CTRL CONC | 0 | 30 | 36.7 | 50 | 100 | 100 | 100 |

TABLE 20
EPHMH

| | 3 | 6 | 1 | 7 | 15 |
|---|---|---|---|---|---|
| | HAT | HAT | DAT | DAT | DAT |
| ROUNDUP W&G | 70 | 80 | 85 | 97 | 100 |
| RTU PLUS | | | | | |
| Form. 126 | 63.3 | 83.3 | 91.7 | 98 | 100 |
| Form. 978 | 21.7 | 43.3 | 85.3 | 97.7 | 100 |
| Form. 973 | 45 | 60 | 88 | 96.3 | 98.3 |
| Form. 921 | 51.7 | 68.3 | 93.7 | 96.7 | 100 |
| ROUNDUP EXTND | 11.7 | 18.3 | 40 | 95 | 100 |
| CTRL CONC | | | | | |

TABLE 21
EUPCP

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 0 | 43.3 | 43.3 | 46.7 | 100 | 100 | 98.3 |
| RTU PLUS | | | | | | | |
| Form. 126 | 6.7 | 20 | 20 | 63.3 | 91.7 | 98.3 | 100 |
| Form. 978 | 0 | 26.7 | 26.7 | 68.3 | 95 | 95 | 100 |
| Form. 973 | 0 | 70 | 71.7 | 83.3 | 98.3 | 100 | 100 |
| Form. 921 | 10 | 71.7 | 70 | 90 | 100 | 100 | 100 |
| ROUNDUP EXTND | 0 | 0 | 0 | 20 | 92 | 93.3 | 98.3 |
| CTRL CONC | | | | | | | |

TABLE 22
LOLMG

| | 3 | 6 | 1 | 3 | 7 | 15 | 30 |
|---|---|---|---|---|---|---|---|
| | HAT | HAT | DAT | DAT | DAT | DAT | DAT |
| ROUNDUP W&G | 68.3 | 73.3 | 76.7 | 94.3 | 98 | 100 | 100 |
| RTU PLUS | | | | | | | |
| Form. 126 | 68.3 | 70 | 80 | 97.7 | 98.3 | 100 | 100 |
| Form. 978 | 31.7 | 43.3 | 50 | 92.7 | 97.3 | 100 | 100 |
| Form. 973 | 41.7 | 50 | 53.3 | 92 | 95.3 | 100 | 100 |
| Form. 921 | 51.7 | 61.7 | 66.7 | 97.7 | 98.3 | 100 | 100 |
| ROUNDUP EXTND | 25 | 28.3 | 31.7 | 63.3 | 73.3 | 100 | 100 |
| CTRL CONC | | | | | | | |

TABLE 23
OXAFL

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 20 | 83.3 | 83.3 | 83.3 | 100 | 100 | 100 |
| RTU PLUS | | | | | | | |
| Form. 126 | 13.3 | 66.7 | 73.3 | 90 | 100 | 100 | 100 |
| Form. 978 | 6.7 | 26.7 | 33.3 | 80 | 100 | 100 | 100 |
| Form. 973 | 40 | 96 | 96.7 | 100 | 100 | 100 | 100 |
| Form. 921 | 36.7 | 93.3 | 95 | 95 | 100 | 100 | 100 |
| ROUNDUP EXTND | 0 | 6.7 | 10 | 43.3 | 100 | 100 | 100 |
| CTRL CONC | | | | | | | |

TABLE 24
OXAST

| | 3 | 6 | 9 | 1 | 7 | 15 | 30 |
|---|---|---|---|---|---|---|---|
| | HAT | HAT | HAT | DAT | DAT | DAT | DAT |
| ROUNDUP W&G | 95 | 95 | 95 | 100 | 100 | 100 | 100 |
| RTU PLUS | | | | | | | |
| Form. 126 | 95 | 95 | 95 | 100 | 100 | 100 | 100 |
| Form. 978 | 76.7 | 85 | 91.7 | 100 | 100 | 100 | 100 |
| Form. 973 | 86.7 | 91.7 | 95 | 100 | 100 | 100 | 100 |
| Form. 921 | 93.3 | 95 | 95 | 100 | 100 | 100 | 100 |
| ROUNDUP EXTND | 12.5 | 20 | 20 | 55 | 100 | 100 | 100 |
| CTRL CONC | | | | | | | |

TABLE 25
PLALA

| | 3 | 6 | 1 | 7 |
|---|---|---|---|---|
| | HAT | HAT | DAT | DAT |
| ROUNDUP W&G RTU | 83.3 | 90 | 96.7 | 100 |
| PLUS | | | | |
| Form. 126 | 75 | 80 | 98.3 | 100 |
| Form. 978 | 0 | 53.3 | 93.3 | 100 |
| Form. 973 | 5 | 35 | 92.5 | 100 |
| Form. 921 | 65 | 68.3 | 90 | 100 |
| ROUNDUP EXTND | 0 | 46.7 | 90 | 98.3 |
| CTRL CONC | | | | |

TABLE 26
POAPW

| | 3 | 6 | 1 | 7 | 15 | 30 |
|---|---|---|---|---|---|---|
| | HAT | HAT | DAT | DAT | DAT | DAT |
| ROUNDUP W&G | 51.7 | 63.3 | 80 | 100 | 100 | 100 |
| RTU PLUS | | | | | | |
| Form. 126 | 53.3 | 65 | 77.7 | 100 | 100 | 100 |
| Form. 978 | 30 | 43.3 | 61.7 | 100 | 100 | 100 |
| Form. 973 | 26.7 | 43.3 | 63.3 | 100 | 100 | 100 |
| Form. 921 | 31.7 | 50 | 75 | 100 | 100 | 100 |
| ROUNDUP EXTND | 18.3 | 23.3 | 30 | 100 | 100 | 100 |
| CTRL CONC | | | | | | |

TABLE 27
STPSW

| | 3 | 6 | 1 | 7 | 15 |
|---|---|---|---|---|---|
| | HAT | HAT | DAT | DAT | DAT |
| ROUNDUP W&G | 5.7 | 17 | 26.7 | 83.3 | 85.7 |
| RTU PLUS | | | | | |
| Form. 126 | 8.3 | 25 | 43.3 | 90 | 97.3 |
| Form. 978 | 3.3 | 4.3 | 16.7 | 95 | 98 |
| Form. 973 | 6 | 7.7 | 18.3 | 88.3 | 96.3 |
| Form. 921 | 5 | 5.7 | 18.3 | 95 | 98.3 |
| ROUNDUP EXTND | 3 | 3.3 | 10 | 81 | 95.7 |
| CTRL CONC | | | | | |

TABLE 28
TRFRE

| | 3 | 6 | 1 | 7 | 15 | 30 |
|---|---|---|---|---|---|---|
| Code | HAT | HAT | DAT | DAT | DAT | DAT |
| ROUNDUP W&G | 54.5 | 18.3 | 67.7 | 91.8 | 93.7 | 92 |
| RTU PLUS | | | | | | |
| Form. 126 | 47 | 15 | 81.9 | 89.6 | 99.4 | 95.7 |
| Form. 978 | 1.5 | 5 | 77.3 | 97.5 | 98.2 | 93.6 |
| Form. 973 | 5.6 | 5 | 94.8 | 99.3 | 100 | 93.5 |
| Form. 921 | 43 | 5 | 96 | 100 | 92.3 | 99.7 |
| ROUNDUP EXTND | 0 | 0 | 35.8 | 97.5 | 98.3 | 98.9 |
| CTRL CONC | | | | | | |

TABLE 29
TAROF

| | 3 | 6 | 1 | 3 | 7 | 15 | 30 |
|---|---|---|---|---|---|---|---|
| Code | HAT | HAT | DAT | DAT | DAT | DAT | DAT |
| ROUNDUP W&G | 63.3 | 68.3 | 76.7 | 89.7 | 94.3 | 99.3 | 95 |
| RTU PLUS | | | | | | | |
| Form. 126 | 60 | 65 | 71.7 | 92.7 | 92.7 | 98.3 | 93.3 |
| Form. 978 | 30 | 33.3 | 41.7 | 74.3 | 84.3 | 94.7 | 84.3 |
| Form. 973 | 50 | 53.3 | 55 | 68.3 | 75 | 92.7 | 89.3 |
| Form. 921 | 41.7 | 46.7 | 50 | 93.7 | 97 | 97 | 93.7 |
| ROUNDUP EXTND | 18.3 | 20 | 20 | 30 | 41.7 | 99 | 90.3 |
| CTRL CONC | | | | | | | |

### Example 4

TABLE 30

| | | | | | | | | | | | | GLYPH: | GLYPH | DIQ: |
|---|---|---|---|---|---|---|---|---|---|---|---|---|---|---|
| | GLYPH | | | | OTH | | | | OTH | DIQ | DIQ | DIQ | IPA:SURF | SURF |
| | IPA wt | | SURF | OTH | 1 | OTH | OTH 2 | OTH | 3 | wt % | wt % | (% ae: | (% ae: | (wt % |
| Code | (% a.e.) | SURF | wt % | 1 | wt % | 2 | wt % | 3 | wt % | (ai) | (ce) | % ce) | wt %) | ce:wt %) |
| STD 1 | 13.3 | T17 | 9 | | | | | | | 0.73 | 0.39 | 34.1:1 | 1.48:1 | 0.04:1 |
| STD 4 | 37.1 | | | | | | | | | | | — | — | — |
| STD 2 | 1.48 | | | | | PA | 2 | | | | | — | — | — |
| STD 3 | 0.74 | | | IMZ | 0.017 | PA | 2 | | | 0.74 | 0.4 | 1.9:1 | — | — |
| Form. 223-E | 0.74 | T17 | 2 | IMZ | 0.017 | PG | 4 | SG15 | 0.01 | 0.04 | 0.02 | 37:1 | 0.37:1 | 0.01:1 |
| Form. 223-F | 0.74 | BER | 2 | IMZ | 0.017 | PG | 4 | SG15 | 0.01 | 0.04 | 0.02 | 37:1 | 0.37:1 | 0.01:1 |
| Form. 223-G | 0.74 | SUR128 | 2 | IMZ | 0.017 | PG | 4 | SG15 | 0.01 | 0.04 | 0.02 | 37:1 | 0.37:1 | 0.01:1 |
| Form. 223-H | 0.74 | SUR128 | 2 | IMZ | 0.017 | | | SG15 | 0.01 | 0.04 | 0.07 | 37.1 | 0.37:1 | 0.01:1 |
| Form. 223-I | — | T17 | 2 | | | | | | | | 0.02 | No | No | 0.01:1 |
| | | | | | | | | | | | | GLYPH | GLYPH | |
| Form. 223-J | 0.74 | | | IMZ | 0.017 | | | SG15 | 0.01 | 0.04 | 0.02 | 37:1 | No SURF | No SURF |
| Form. 223-Q | 0.74 | BER | 2 | IMZ | 0.017 | | | SG15 | 0.01 | 0.04 | 0.02 | 37:1 | 0.37:1 | 0.01:1 |
| Form. 919 | 0.74 | T17 | 2 | IMZ | 0.017 | | | SG15 | 0.01 | 0.04 | 0.02 | 37:1 | 0.37:1 | 0.01:1 |
| Form. 973 | 0.74 | T17 | 2 | IMZ | 0.017 | PG | 4 | SG15 | 0.01 | 0.04 | 0.02 | 37:1 | 0.37:1 | 0.01:1 |

### Greenhouse Test Results for Example 4

TABLE 31
POROL

| Code | 1 HAT | 3 HAT | 6 HAT | 1 DAT | 7 DAT | 21 DAT |
|---|---|---|---|---|---|---|
| STD 1 | 2.0 | 5.0 | 13.3 | 53.3 | 94.3 | 100.0 |
| STD 4 | 0.0 | 0.0 | 0.0 | 3.3 | 94.0 | 100.0 |
| STD 2 | 15.0 | 65.0 | 80.0 | 94.3 | 99.3 | 100.0 |
| STD 3 | 13.3 | 65.0 | 78.3 | 88.3 | 96.0 | 100.0 |
| Form. 223-E | 6.7 | 25.0 | 65.0 | 89.0 | 97.3 | 99.7 |
| Form. 223-F | 5.7 | 25.0 | 65.0 | 88.3 | 98.3 | 100.0 |
| Form. 223-G | 5.0 | 25.0 | 68.3 | 88.3 | 98.3 | 100.0 |
| Form. 223-H | 5.0 | 20.0 | 65.0 | 86.3 | 97.7 | 99.0 |
| Form. 223-I | 7.0 | 25.0 | 55.0 | 76.7 | 85.0 | 10.0 |
| Form. 223-J | 0.0 | 0.0 | 8.3 | 35.0 | 90.0 | 92.0 |
| Form. 223-Q | 4.7 | 25.0 | 63.3 | 88.3 | 98.3 | 100.0 |
| Form. 919 | 3.7 | 20.0 | 58.3 | 86.7 | 97.7 | 99.7 |
| Form. 973 | 4.0 | 26.7 | 75.0 | 93.3 | 99.0 | 100.0 |
| UNTREATED | 0.0 | 0.0 | 0.0 | 0.0 | 0.0 | 0.0 |
| CHECK | | | | | | |

TABLE 32
DIGSA

| Code | 1 HAT | 3 HAT | 6 HAT | 1 DAT | 7 DAT | 21 DAT |
|---|---|---|---|---|---|---|
| STD 1 | 0.0 | 0.0 | 15.0 | 53.3 | 92.7 | 99.0 |
| STD 4 | 0.0 | 0.0 | 0.0 | 1.7 | 99.0 | 100.0 |
| STD 2 | 15.0 | 60.0 | 85.0 | 95.7 | 100.0 | 100.0 |
| STD 3 | 15.0 | 63.3 | 90.0 | 97.0 | 100.0 | 100.0 |
| Form. 223-E | 5.0 | 25.0 | 75.0 | 97.0 | 99.7 | 100.0 |
| Form. 223-F | 5.0 | 20.0 | 65.0 | 95.0 | 99.7 | 100.0 |
| Form. 223-G | 5.0 | 25.0 | 71.7 | 92.3 | 98.0 | 99.3 |
| Form. 223-H | 5.0 | 25.0 | 65.0 | 95.0 | 99.0 | 100.0 |
| Form. 223-I | 9.0 | 26.7 | 41.7 | 83.3 | 83.7 | 13.3 |
| Form. 223-J | 0.0 | 0.0 | 5.0 | 26.7 | 90.0 | 98.7 |
| Form. 223-Q | 5.0 | 26.7 | 71.7 | 97.0 | 99.7 | 100.0 |
| Form. 919 | 3.0 | 28.3 | 75.0 | 96.7 | 99.3 | 99.7 |
| Form. 973 | 5.7 | 25.0 | 68.3 | 95.0 | 98.7 | 99.3 |
| UNTREATED | 0.0 | 0.0 | 0.0 | 0.0 | 0.0 | 0.0 |
| CHECK | | | | | | |

TABLE 33
TRFRE

| Code | 1 HAT | 3 HAT | 6 HAT | 1 DAT | 7 DAT | 21 DAT |
|---|---|---|---|---|---|---|
| STD 1 | 3.3 | 40.0 | 51.7 | 75.0 | 91.3 | 89.3 |
| STD 4 | 0.0 | 1.7 | 1.7 | 36.7 | 91.7 | 100.0 |
| STD 2 | 48.3 | 78.3 | 85.0 | 93.3 | 95.7 | 94.0 |
| STD 3 | 50.0 | 75.0 | 81.7 | 91.0 | 94.0 | 94.7 |
| Form. 223-E | 33.3 | 56.7 | 70.0 | 93.3 | 97.7 | 96.7 |
| Form. 223-F | 33.3 | 60.0 | 71.7 | 90.7 | 95.7 | 96.0 |
| Form. 223-G | 35.0 | 55.0 | 68.3 | 85.0 | 95.3 | 96.0 |
| Form. 223-H | 38.3 | 56.7 | 68.3 | 90.0 | 95.0 | 96.3 |
| Form. 223-I | 28.3 | 53.3 | 71.7 | 75.0 | 73.3 | 11.7 |
| Form. 223-J | 0.0 | 0.0 | 0.0 | 16.7 | 90.7 | 94.3 |
| Form. 223-Q | 41.7 | 55.0 | 75.0 | 91.3 | 94.7 | 95.0 |
| Form. 919 | 41.7 | 63.3 | 76.7 | 94.3 | 98.7 | 99.0 |
| Form. 973 | 40.0 | 65.0 | 78.3 | 94.7 | 98.0 | 98.0 |
| UNTREATED | 0.0 | 0.0 | 0.0 | 0.0 | 0.0 | 0.0 |
| CHECK | | | | | | |

TABLE 34
FESAR

| Code | 1 HAT | 3 HAT | 6 HAT | 1 DAT | 7 DAT | 21 DAT |
|---|---|---|---|---|---|---|
| STD 1 | 0.0 | 5.0 | 16.7 | 48.3 | 89.0 | 97.0 |
| STD 4 | 0.0 | 0.0 | 0.0 | 20.0 | 70.0 | 98.7 |
| STD 2 | 5.0 | 28.3 | 51.7 | 89.3 | 98.3 | 100.0 |
| STD 3 | 5.0 | 30.0 | 51.7 | 81.7 | 98.0 | 100.0 |
| Form. 223-E | 0.0 | 13.3 | 20.0 | 73.3 | 97.0 | 99.3 |
| Form. 223-F | 0.0 | 20.0 | 48.3 | 76.7 | 98.3 | 99.3 |
| Form. 223-G | 0.0 | 15.0 | 36.7 | 68.3 | 93.0 | 97.3 |
| Form. 223-H | 0.0 | 11.7 | 25.0 | 61.7 | 87.7 | 95.7 |
| Form. 223-I | 0.0 | 6.7 | 18.3 | 46.7 | 51.7 | 33.3 |
| Form. 223-J | 0.0 | 0.0 | 5.0 | 15.0 | 80.0 | 96.3 |
| Form. 223-Q | 0.0 | 15.0 | 30.0 | 80.0 | 98.7 | 99.7 |
| Form. 919 | 0.0 | 13.3 | 21.7 | 68.3 | 98.0 | 98.7 |
| Form. 973 | 0.0 | 8.3 | 21.7 | 75.0 | 97.7 | 99.3 |
| UNTREATED | 0.0 | 0.0 | 0.0 | 0.0 | 0.0 | 0.0 |
| CHECK | | | | | | |

Discussion

At 1 HAT test formulations provided lower POROL. DIGSA, and FESAR control compared to STD 2 and STD 3. However. Formulation 223-H, Formulation 223-Q, Formulation 919, and Formulation 973 provided comparable results to STD 2 and STD3 at 1 HAT for TRFRE.

At 1 DAT most test formulations provided equivalent levels of control to the standard formulations. Formulation 223-I and Formulation 223-J did not provide equivalent levels of control, but were lacking glyphosate and a surfactant respectively. Most test formulations provided at least about 85% control at 1 DAT. This trend continued from 7 DAT to 21 DAT, with most test formulations providing similar levels of control to the standard formulations, with the exception of Formulation 223-I and Formulation 223-J.

Therefore, Example 4 demonstrates that levels of plant control comparable to the standard formulations be achieved using the test formulations set forth above. In particular, similar efficacy can be observed for formulations containing glyphosate, an alcohol ethoxylate surfactant, and diquat.

Clarity Test and Results

Experimental formulations were maintained at constant temperature for a fixed period and monitored for changes in color, homogeneity and appearance. The formulations were also cycled through temperature extremes (i.e., at low temperatures of −20° C., and −5° C. for the fixed period then raised to the higher temperatures of 20° C., and 5° C., respectively) and changes monitored. Results are presented in Table 35 below.

TABLE 35

| | Specific | Cloud | |
|---|---|---|---|
| | Gravity | Point | |
| Code | (20/15.6° C.) | (° C.) | Appearance |
| Form. 126 | 1.0200 | n/a | Clear, pale |
| | | | amber liquid |
| Form. 913 | 1.0045 | n/a | Clear, pale |
| | | | amber liquid |
| Form. 914 | 1.0045 | n/a | Clear, pale |
| | | | amber liquid |
| Form. 915 | 1.0044 | n/a | Clear, pale |
| | | | amber liquid |

When introducing elements of the present invention or the preferred embodiments(s) thereof, the articles “a”, “an”, “the” and “said” are intended to mean that there are one or more of the elements. The terms “comprising”. “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description shall be interpreted as illustrative and not in a limiting sense.

What is claimed is:

1. An aqueous herbicidal composition useful for killing or controlling the growth of unwanted plants, the composition comprising:
an organophosphorus herbicide or a herbicidal derivative thereof;
bipyridilium or a herbicidal derivative thereof; and
an alkoxylated alcohol surfactant wherein:
bipyridilium (ce) is present at a weight ratio to the alkoxylated alcohol surfactant to bipyridilium (ce) of less than about 0.1:1.

2. The composition of claim 1, wherein bipyridilium (ce) is present at a weight ratio to the alkoxylated alcohol surfactant to bipyridilium (cc) of less than about 0.09:1, less than about 0.08:1, less than about 0.07:1, less than about 0.06:1, less than about 0.05:1, less than about 0.04:1, less than about 0.03:1, or less than about 0.02:1.

3. The composition of claim 1 or 2, wherein bipyridilium (ce) is present at a concentration of less than about 1 wt %, less than about 0.5 wt %, less than about 0.25 wt %, or less than about 0.2 wt % of the composition.

4. The composition of claim 1 or 2, wherein bipyridilium (ce) is present at a concentration of less than about 0.15 wt %, less than about 0.1 wt %, or less than about 0.05 wt % of the composition.

5. The composition of any of the preceding claims, wherein the alkoxylated alcohol surfactant is present in a concentration of at least about 10 g/L, at least about 12 g/L, at least about 15 g/L, or at least about 20 g/L of the composition.

6. The composition of any of the preceding claims, wherein the organophosphorus herbicide is selected from the group consisting of glyphosate, glufosinate, and combinations thereof.

7. The composition of claim 6, wherein the organophosphorus herbicide is glyphosate or a herbicidal derivative thereof.

8. The composition of claim 7, wherein the weight ratio of glyphosate (ae) to bipyridilium (ce) is at least about 10:1, at least about 15:1, at least about 20:1, at least about 25:1, at least about 30:1, or at least about 35:1.

9. The composition of claim 7 or 8, wherein the weight ratio of glyphosate (ae) to bipyridilium (ce) is from about 10:1 to about 50:1, from about 15:1 to about 45:1, from about 20:1 to about 40:1, from about 25:1 to about 40:1, from about 30:1 to about 40:1, or from about 35:1 to about 40:1.

10. The composition of claim 6, wherein the organophosphorus herbicide is glufosinate or a herbicidal derivative thereof.

11. The composition of claim 10, wherein the weight ratio of glufosinate (ae) to bipyridilium (ce) is at least about 10:1, at least about 15:1, at least about 20:1, at least about 25:1, at least about 30:1, or at least about 35:1.

12. The composition of claim 10 or 11, wherein the weight ratio of glufosinate (ae) to bipyridilium (ce) is from about 10:1 to about 50:1, from about 15:1 to about 45:1, from about 20:1 to about 40:1, from about 25:1 to about 40:1, from about 30:1 to about 40:1, or from about 35:1 to about 40:1

13. An aqueous herbicidal composition useful for killing or controlling the growth of unwanted plants, the composition comprising:
an organophosphorus herbicide or a herbicidal derivative thereof;
bipyridilium or a herbicidal derivative thereof; and
an alkoxylated alcohol surfactant; wherein:
the weight ratio of alkoxylated alcohol surfactant to glyphosate (ae) is greater than about 0.75:1.

14. The composition of claim 13, wherein the organophosphorus herbicide is selected from the group consisting of glyphosate, glufosinate, and combinations thereof.

15. The composition of claim 14, wherein the organophosphorus herbicide is glyphosate or a herbicidal derivative thereof.

16. The composition of claim 15, wherein the weight ratio of alkoxylated alcohol surfactant to glyphosate (ae) is greater than about 1:1, greater than about 1.25:1, greater than about 1.5:1, greater than about 2:1, or greater than about 2.5:1.

17. The composition of claim 16, wherein the weight ratio of alkoxylated alcohol surfactant to glyphosate (ae) is less than about 5:1 or less than about 4:1.

18. The composition of claim 14, wherein the organophosphorus herbicide is glufosinate or a herbicidal derivative thereof.

19. The composition of claim 18, wherein the weight ratio of alkoxylated alcohol surfactant to glufosinate (ae) is greater than about 1:1, greater than about 1.25:1, greater than about 1.5:1, greater than about 2:1, or greater than about 2.5:1.

20. The composition of claim 19, wherein the weight ratio of alkoxylated alcohol surfactant to glufosinate (ae) is less than about 5:1 or less than about 4:1.

21. The composition of any of claims 13 to 20, wherein the alkoxylated alcohol surfactant is present in a concentration of at least about 10 g/L, at least about 12 g/L, at least about 15 g/L, or at least about 20 g/L of the composition.

22. The composition of any of claims 13, 15 to 17, or 21, wherein glyphosate (ac) is present at a concentration of at least about 0.25 wt %, at least about 0.5 wt %, or at least about 0.75 wt % of the composition.

23. The composition of any of claims 13, 15 to 17, or 21, wherein glyphosate (ae) is present at a concentration of from about 0.25 wt % to about 2 wt %, from about 0.5 to about 1.5 wt %, or from about 0.5 to about 1 wt % of the composition.

24. The composition of any of claims 13 or 18 to 21, wherein glufosinate (ae) is present at a concentration of at least about 0.25 wt %, at least about 0.5 wt %, or at least about 0.75 wt % of the composition.

25. The composition of any of claims 13 or 18 to 21, wherein glufosinate (ae) is present at a concentration of from about 0.25 wt % to about 2 wt %, from about 0.5 to about 1.5 wt %, or from about 0.5 to about 1 wt % of the composition.

26. The composition of any of claims 13 to 25 wherein bipyridilium (ce) is present at a concentration of less than about 1 wt %, less than about 0.5 wt %, less than about 0.25 wt %, less than about 0.15 wt %, less than about 0.1 wt %, or less than about 0.05 wt % of the composition.

27. The composition of any of claims 13 to 25 wherein bipyridilium (ce) is present at a concentration of from about 0.01 to about 0.5 wt %, from about 0.01 to about 0.25 wt %, from about 0.01 to about 0.1 wt %, or from about 0.01 to about 0.05 wt % of the composition.

28. The composition of any of claims 13 to 25, wherein bipyridilium (ce) is present at a weight ratio to the alkoxylated alcohol surfactant of no more than about 1:1, no more than about 0.5:1, no more than about 0.25:1, no more than about 0.1:1, no more than about 0.05:1, or no more than about 0.025:1.

29. The composition of any of claims 13, 15 to 17, 21 to 23, or 26 to 28, wherein the weight ratio of glyphosate (ae) to bipyridilium (ce) is at least about 10:1, at least about 15:1, at least about 20:1, at least about 25:1, at least about 30:1, or at least about 35:1.

30. The composition of any of claims 13, 15 to 17, 21 to 23, or 26 to 28, wherein the weight ratio of glyphosate (ae) to bipyridilium (ce) is from about 10:1 to about 50:1, from about 15:1 to about 45:1, from about 20:1 to about 40:1, from about 25:1 to about 40:1, from about 30:1 to about 40:1, or from about 35:1 to about 40:1.

31. The composition of any of claims 13, 18 to 21, or 24 to 28, wherein the weight ratio of glufosinate (ac) to bipyridilium (ce) is at least about 10:1, at least about 15:1, at least about 20:1, at least about 25:1, at least about 30:1, or at least about 35:1.

32. The composition of any of claims 13, 18 to 21, or 24 to 28, wherein the weight ratio of glufosinate (ae) to bipyridilium (ce) is from about 10:1 to about 50:1, from about 15:1 to about 45:1, from about 20:1 to about 40:1, from about 25:1 to about 40:1, from about 30:1 to about 40:1, or from about 35:1 to about 40:1.

33. The composition of any of claims 1 to 32, wherein the alkoxylated alcohol surfactant has the formula:
R¹O—(R²O)ₓR³
wherein:
R¹ is nonaromatic, hydrocarbyl or substituted hydrocarbyl having from 8 to 20 carbon atoms;
R² in each of the x (R²O) groups is independently C₂ to C₄ alkylene;
R³ is hydrogen, or a linear or branched alkyl group having from 1 to 4 carbon atoms;
x is from about 2 to about 20.

34. The composition of claim 33, wherein R¹ is a linear or minimally branched alkyl or alkenyl group having an average of from 8 to 20 carbon atoms, or from 10 to 14 carbon atoms, and no more than two methyl substituents.

35. The composition of claim 34, wherein R¹ is a linear alkyl or alkenyl group having an average of from 8 to 20 carbon atoms, or from 10 to 14 carbon atoms, and no more than two methyl substituents.

36. The composition of any of claims 33 to 35, wherein each R²O group is ethylene.

37. The composition of any of claims 33 to 36, wherein the average value of x is from about 3 to about 12 or from about 5 to about 9.

38. The composition of any of claims 1 to 37, wherein the composition does not include an agronomically acceptable inorganic ammonium salt selected from the group consisting of ammonium sulfate, ammonium nitrate, ammonium thiocyanate, ammonium phosphate, ammonium chloride and mixtures thereof.

39. The composition of any of claims 1 to 38, further comprising an herbicidal active selected from the group consisting of 2,4-D, 2,4-DB, MCPA, dicamba, glufosinate, glyphosate, imazapic, imazapyr, imazethapyr, triclopyr, and combinations thereof.

40. An aqueous herbicidal composition useful for killing or controlling the growth of unwanted plants, the composition comprising:
an organophosphorus herbicide or a herbicidal derivative thereof;
bipyridilium or a herbicidal derivative thereof; and
an alkoxylated alcohol surfactant; wherein:
the organophosphorus herbicide (ae) is present at a concentration of from about 0.25 wt % to about 2 wt %;
bipyridilium (ce) is present at a concentration of from about 0.01 wt % to about 1 wt %; and
the alkoxylated alcohol surfactant is present at a concentration of from about 0.25 wt % to about 2 wt %.

41. The composition of claim 40, wherein the organophosphorus herbicide is selected from the group consisting of glyphosate, glufosinate, and combinations thereof.

42. The composition of claim 41, wherein the organophosphorus herbicide is glyphosate or a herbicidal derivative thereof.

43. The composition of claim 41, wherein the organophosphorus herbicide is glufosinate or a herbicidal derivative thereof.

44. An aqueous herbicidal composition useful for killing or controlling the growth of unwanted plants, the composition comprising:
an organophosphorus herbicide or a herbicidal derivative thereof;
bipyridilium or a herbicidal derivative thereof; and
an alkoxylated alcohol surfactant; wherein:
the composition does not comprise an inorganic ammonium salt selected from the group consisting of ammonium sulfate, ammonium nitrate, ammonium thiocyanate, ammonium phosphate, ammonium chloride and mixtures thereof.

45. The composition of claim 44, wherein the organophosphorus herbicide is selected from the group consisting of glyphosate, glufosinate, and combinations thereof.

46. The composition of claim 45, wherein the organophosphorus herbicide is glyphosate or a herbicidal derivative thereof.

47. The composition of claim 45, wherein the organophosphorus herbicide is glufosinate or a herbicidal derivative thereof.

48. An aqueous herbicidal composition useful for killing or controlling the growth of unwanted plants, the composition comprising:
glyphosate or a herbicidal derivative thereof;
bipyridilium or a herbicidal derivative thereof;
an active selected from the group consisting of 2,4-D, 2,4-DB, MCPA, dicamba, glufosinate, imazapic, imazapyr, imazethapyr, triclopyr, and combinations thereof; and an alkoxylated alcohol surfactant.

49. An aqueous herbicidal composition useful for killing or controlling the growth of unwanted plants, the composition comprising:
glufosinate or a herbicidal derivative thereof;
bipyridilium or a herbicidal derivative thereof;
an active selected from the group consisting of 2,4-D, 2,4-DB, MCPA, dicamba, glyphosate, imazapic, imazapyr, imazethapyr, triclopyr, and combinations thereof; and
an alkoxylated alcohol surfactant.

50. A method of killing or controlling weeds or unwanted vegetation, the method comprising:
applying a herbicidally effective amount of the composition of any of claims 1 to 49 to the foliage of the weeds or unwanted vegetation, wherein greater visual symptoms of herbicidal treatment are provided within 1 hour after treatment, 3 hours after treatment, 1 day after treatment (1 DAT), 3 DAT, 14 DAT, and/or 21 DAT as compared to a reference application mixture that did not contain the alkoxylated alcohol surfactant.
